(19) United States
(12) Patent Application Publication
(10) Pub. No.: US 2024/0400804 A1
(43) Pub. Date: Dec. 5, 2024

(54) Polyethylene Blends, Films Thereof, and Methods Thereof

(71) Applicant: ExxonMobil Technology and Engineering Company-Chem, Baytown, TX (US)

(72) Inventors: Nino RUOCCO, Houston, TX (US); Maria Josefina CARBONE, Testelt (BE); Etienne RH LERNOUX, Longueville (FR); Michael A. LEAF, Baytown, TX (US); Wen LI, Houston, TX (US); Adriana S. SILVA, Houston, TX (US)

(21) Appl. No.: 18/696,216

(22) PCT Filed: Oct. 4, 2022
(86) PCT No.: PCT/US2022/077527

§ 371 Date: Mar. 27, 2024

Related U.S. Application Data
(60) Provisional application No. 63/262,062, filed on Oct. 4, 2021.

(51) Int. Cl. C08L 23/08; C08J 5/18

(52) U.S. Cl. CPC C08L 23/0815; C08J 5/18; C08J 2323/08; C08J 2423/06; C08L 2203/16; C08L 2205/025; C08L 2207/062; C08L 2207/066

(57) ABSTRACT

The present disclosure relates to polyethylene blends, films thereof, and methods thereof. In at least one embodiment, a polymer blend includes a first polyethylene having a density of about 0.94 g/cm³ to about 0.97 g/cm³ and a melt index of about 0.1 g/10 min to about 10 g/10 min. The blend includes a second polyethylene comprising at least 80 wt % ethylene derived-units. The second polyethylene has a density of about 0.918 g/cm³ to about 0.945 g/cm³, a number average molecular weight (Mn) of about 10,000 g/mol to about 20,000 g/mol, a weight-average molecular weight (Mw) of about 75,000 g/mol to about 300,000 g/mol, a melt index (2.16 kg) of about 0.1 g/10 min to about 5 g/10 min, a high load melt index (21.6 kg) of about 25 g/10 min to about 80 g/10 min, and a melt index ratio of about 10 to about 50.

### CROSS REFERENCE TO RELATED APPLICATION

This application claims the benefit of U.S. Provisional Application 63/262,062 filed Oct. 4, 2021 entitled “Polyethylene Blends, Films Thereof, and Methods Thereof”, the entirety of which is incorporated by reference herein.

### FIELD

The present disclosure generally relates to polyethylene blends, films thereof, and methods thereof.

### BACKGROUND

Toughness and stiffness are key properties of polyethylene films, for example where down-gauging is desired. Examples of applications where toughness and stiffness of the film are key include stand-up pouches, sachets, pillow packs, and heavy-duty sacks. Toughness can be characterized via dart impact resistance, Elmendorf tear resistance in the machine direction is (“MD Tear”), and/or bag integrity after free fall. Stiffness can be characterized by 1% secant modulus (also referred to herein as “modulus”)

Few polyethylene blends are currently available which offer both high MD tear and dart impact in film performance. Even fewer polyethylene blends offer a favorable combination of the film properties: MD tear, dart impact and secant modulus. Balancing these three film properties through use of polyethylene blends can be difficult. In polyethylene blends, linear low density polyethylene (“LLDPE”) is the primary contributor of increased toughness (e.g., dart impact). Increased stiffness (e.g., 1% secant modulus), on the other hand, can be attributable to the addition of high density polyethylene (“HDPE”) to the blend. HDPE, however, decreases the overall toughness (MD tear and dart impact) of the film, making the film more brittle. Hence, the MD tear and the dart impact values of the film sharply decreases with increasing density of the polyethylene blend while the stiffness or modulus of the film is improved. For applications such as packaging, a stiff film is needed, but toughness should be maintained.

There is a need for polyethylene blends that can avoid or minimize this trade-off of achieving greater stiffness at the expense of toughness; that is, blends that can extend the range of densities (thereby improving stiffness) while maintaining or improving toughness (which may be referred to as “extending the dart plateau and the tear plateau”). Such films could provide advantageous performance properties, particularly, a combination of high dart impact, high MD tear, and high 1% secant modulus.

References of potential interest in this regard include: PCT/US2021/020614; WO2022/120321; US Publication Nos. 2019/0119417, 2019/0144576, and 2020/0071437; WO2019/094131; EP 2931763 B1; EP 2188100 B1; WO2019/027605 A1; WO2019/083609.

### SUMMARY

The present disclosure relates to polyethylene blends, films thereof, and methods thereof.

In at least one embodiment, a polymer blend includes a first polyethylene having a density of about 0.94 g/cm³ to about 0.97 g/cm³ and a melt index of about 0.1 g/10 min to about 10 g/10 min. The blend includes a second polyethylene including at least 80 wt % ethylene derived-units. The second polyethylene has a density of greater than 0.918 g/cm³ to about 0.945 g/cm³, a number average molecular weight (Mn) of about 10,000 g/mol to about 20,000 g/mol, a weight-average molecular weight (Mw) of about 75,000 g/mol to about 300,000 g/mol, a melt index (2.16 kg) of about 0.1 g/10 min to about 5 g/10 min, a high load melt index (21.6 kg) of about 25 g/10 min to about 80 g/10 min, and a melt index ratio of about 10 to about 50.

### BRIEF DESCRIPTION OF THE DRAWINGS

FIG. 1A is a graph illustrating the GPC4D results of various resins consistent with various embodiments, as well as of comparative resins.

FIG. 1B is a graph illustrating the GPC4D results of various resins consistent with various embodiments, as well as of comparative resins.

FIG. 2 is a graph illustrating TREF results of resins consistent with various embodiments, as well as of comparative resins.

FIG. 3A is a graph illustrating dart drop versus 1% secant modulus of a film consistent with various embodiments, as well as of a comparative film.

FIG. 3B is a graph illustrating dart drop versus 1% secant modulus of a film consistent with various embodiments.

FIG. 3C is a graph illustrating Elmendorf tear (MD) versus 1% secant modulus of a film consistent with various embodiments, as well as of a comparative film.

FIG. 3D is a graph illustrating Elmendorf tear (MD) versus 1% secant modulus of a film consistent with various embodiments, as well as of comparative films.

FIG. 4A is a graph illustrating dart impact versus 1% secant modulus (MD) for a coextruded structure in accordance with various embodiments, as well as of comparative coextruded structures.

FIG. 4B is a graph illustrating Elmendorf tear (MD) versus 10% secant modulus (MD) for coextruded structures in accordance with various embodiments, as well as of comparative coextruded structures.

FIG. 5 is a graph illustrating Elmendorf tear (MD) versus 1% secant modulus (MD) for a coextruded structure in accordance with various embodiments, as well as of comparative coextruded structures.

### DETAILED DESCRIPTION

The present disclosure relates to polyethylene blends, films thereof, and methods thereof. In at least one embodiment, a polymer blend includes a first polyethylene having a density of about 0.94 g/cm³ to about 0.97 g/cm³ and a melt index of about 0.1 g/10 min to about 10 g/10 min. The polymer blend includes a second polyethylene having at least 80 wt % ethylene derived-units and having a density of greater than about 0.918 g/cm³ to about 0.945 g/cm³, a number average molecular weight (Mn) of about 10,000 g/mol to about 20,000 g/mol, and a weight-average molecular weight (Mw) of about 75,000 g/mol to about 300,000 g/mol. The second polyethylene preferably has a broad orthogonal composition distribution (BOCD), as described in more detail herein below.

The inventors have found that by using a unique class of polymers (having a density greater than 0.918 g/cm³) for mixing with an HDPE, blends (and films thereof) may be obtained that can achieve improved stiffness while not sacrificing toughness; that is, they extend the dart plateau and the tear plateau beyond that of prior blends/films. Blends/films of the present disclosure can provide improved toughness and stiffness, namely a combination of high dart impact, high MD tear, and high 1% secant modulus. Without being bound by theory, it is believed that the extended dart plateau and tear plateau are a result of the homogeneous distribution (“synergy”) between the second polyethylene and the HDPE. This synergy may be expressed as a sigma T (also referred to as “σ_{T}(° C.)”) as described in more detail below. Such synergy may be provided by one or more unique properties of the polymers having a density greater than 0.918 g/cm³, and such properties including BOCD, a low number average molecular weight (Mn), and broad polydispersity indices (PDI, also referred to as molecular weight distribution (MWD) or Mw/Mn). Such polymers may also exhibit multimodality as described herein.

Before the present compounds, components, compositions, and/or methods are disclosed and described, it is to be understood that unless otherwise indicated this present disclosure is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions apply:

The terms “a” and “the” as used herein are understood to encompass the plural as s well as the singular.

The term “alpha-olefin” or “α-olefin” refers to an olefin having a terminal carbon-to-carbon double bond in the structure thereof (R¹R²)—C═CH₂, where R¹ and R² can be independently hydrogen or any hydrocarbyl group. In an aspect, R¹ is hydrogen, and R² is an alkyl group. A “linear alpha-olefin” is an alpha-olefin as defined in this paragraph wherein R¹ is hydrogen, and R² is hydrogen or a linear alkyl group.

The term “average” when used to describe a physical property measured in multiple directions, means the average value of the property in each direction. For example, secant modulus can be measured by straining an object in the machine direction (“MD”) or in the transverse direction (“TD”). The “average MD/TD 1% secant modulus” or “average 1% secant is modulus” thus refers to the average of the MD secant modulus and the TD secant modulus at 1% strain.

The term “catalyst system” may include one or more polymerization catalysts, activators, supports/carriers, or any combination thereof.

The term “comonomer” refers to the unique mer units in a copolymer. The composition of the copolymer varies at different molecular weights. As with MWD, comonomer composition must be represented as a distribution rather than as a single value. The term “composition distribution,” or “comonomer distribution,” is a measure of the spread of a copolymer's comonomer composition. Composition distribution is typically characterized as “broad” or “narrow.”

The term “copolymer” refers to polymers having more than one type of monomer, including interpolymers, terpolymers, or higher order polymers.

All numerical values within the detailed description and the claims herein are modified by “about” or “approximately” the indicated value, taking into account experimental error and variations.

Unless otherwise specified, the term “density” refers to the density of the polyethylene or polyethylene blend independent of any additives which may change the tested value.

The terms “dispose,” “disposed” or “disposed on” mean or refer to location, proximity, juxtaposition or placement of a layer (also referred to herein as a “skin” or a “subskin” or “sealant”) to another layer. The terms, dispose, disposed, or disposed on can refer to two or more layers which are attached, extruded, or otherwise combined or, in the alternative, two or more layers which are not attached, extruded or otherwise combined. Further, to dispose or dispose on is not limited to any particular methodology of attachment or placement, but refers simply to the proximity or juxtaposition of one layer in relation to another layer.

Multilayer films may be referred to in terms of “layers” (i.e. a first layer, a second layer, a third layer, a core layer, an outer layer, an inner layer, etc.) or in terms of “skins” (i.e. a core, a skin, and a subskin). Layer terminology and skin terminology are interchangeable and convey no functional nor structural differences.

The term “linear low density polyethylene” (“LLDPE”) means polyethylene having a significant number of short branches. LLDPEs can be distinguished structurally from conventional LDPEs because LLDPEs typically have minimal long chain branching and more short chain branching than LDPEs.

The term “metallocene catalyst” refers to a catalyst having at least one transition is metal compound containing one or more substituted or unsubstituted cyclopentadienyl (Cp) moiety (typically two Cp moieties) in combination with a Group 4, 5, or 6 transition metal. A metallocene catalyst is considered a single site catalyst. Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (such as methyl alumoxane), an ionizing activator, a Lewis acid, or a combination thereof. Alkylalumoxanes (such as methyl alumoxane and modified methylalumoxanes) are particularly suitable as catalyst activators. The catalyst system can be supported on a carrier, typically an inorganic oxide or chloride or a resinous material such as, for example, polyethylene or silica. When used in relation to metallocene catalysts, the term “substituted” means that a hydrogen group has been replaced with a hydrocarbyl group, a heteroatom, or a heteroatom containing group. For example, methylcyclopentadiene is a Cp group substituted with a methyl group.

The term “melt index” (“MI”) is the number of grams extruded in 10 minutes under the action of a standard load (2.16 kg) and is an inverse measure of viscosity. A high MI implies low viscosity and a low MI implies high viscosity. In addition, polymers can have shear thinning behavior, which means that their resistance to flow decreases as the shear rate increases. This is due to, e.g., molecular alignments in the direction of flow and disentanglements.

As provided herein, MI (I₂) is determined according to ASTM D1238-E (190° C./2.16 kg), also sometimes referred to as I₂ or I_{2.16}.

The term “high load melt index” (“HLMI”), is the number of grams extruded in 10 minutes under the action of a standard load (21.6 kg) and is an inverse measure of viscosity. As provided herein, HLMI (I₂₁) is determined according to ASTM D1238 (190° C./21.6 kg) and is also sometimes referred to as I₂₁ or I_{21.6}.

The “melt index ratio” (“MIR”) provides an indication of the amount of shear thinning behavior of the polymer and is a parameter that can be correlated to the overall polymer mixture molecular weight distribution data obtained separately by using Gel Permeation Chromatography (“GPC”) and possibly in combination with another polymer analysis including TREF. MIR is the ratio of I₂₁/I₂ (or HLMI/MI).

As used herein, “Mₙ” is number average molecular weight, “Mu” is weight average is molecular weight, and “M_{z}” is z-average molecular weight. Unless otherwise noted, all molecular weight units (e.g., M_{w}, Mₙ, M_{z}) including molecular weight data are in the unit of g·mol⁻¹.

As used herein, unless specified otherwise, percent by mole is expressed as “mole %,” and percent by weight is expressed as “wt %”

As used herein, the term “olefin” refers to a linear, branched, or cyclic compound comprising carbon and hydrogen and having a hydrocarbon chain containing at least one carbon-to-carbon double bond in the structure thereof, where the carbon-to-carbon double bond does not constitute a part of an aromatic ring. The term olefin includes all structural isomeric forms of olefins, unless it is specified to mean a single isomer or the context clearly indicates otherwise.

As used herein, the term “polymer” refers to a compound having two or more of the same or different “mer” units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically.

As used herein, when a polymer or copolymer is referred to as comprising an olefin, the olefin present in such polymer or copolymer is the polymerized form of the olefin. For example, when a copolymer is said to have a “propylene” content of 35 wt. % to 55 wt. %, it is understood that the mer unit in the copolymer is derived from propylene in the polymerization reaction and said derived units are present at 35 wt. % to 55 wt. %, based upon the weight of the copolymer. A copolymer can be terpolymers and the like.

As used herein, the terms “polymerization temperature” and “reactor temperature” are interchangeable.

In an extrusion process, “viscosity” is a measure of resistance to shearing flow. Shearing is the motion of a fluid, layer-by-layer, like a deck of cards. When polymers flow through straight tubes or channels, the polymers are sheared and resistance is expressed in terms of viscosity.

Various measurements described herein may be based on certain standardized testing procedures. For example, measurements of tensile strength in the machine direction (MD) and transverse direction (TD) can be made by following the procedure of ASTM D882. Measurements of yield strength in MD and TD can be made by following the procedure of ASTM D882. Measurements of Elmendorf tear strength in MD and TD can be made by is following the procedure of ASTM D1922-09.

The “secant modulus” is the slope of a line connecting the origin to an object's stress/strain curve at a specified strain percentage. For example, the “1% secant modulus” is the slope of a line connecting the origin to an object's stress/strain curve at 1% strain. The secant modulus describes the overall stiffness of an object. Lower strain percentages typically approximate elastic behavior more accurately.

The term “tensile strength” refers to the stretching force required to inelastically deform a material. The tensile strength of a material can be measured by stretching the material in MD or TD. Tensile strength is measured in psi and can be tested via ASTM D882-10. High Density Polyethylene

Blends of the present disclosure, and films thereof, include a first polymer that is a high density polyethylene (HDPE). HDPEs of the present disclosure can be produced using any suitable method or alternatively obtained from commercial source(s). In some embodiments, an HDPE has a comonomer content of about 0.01 wt % to about 5 wt %, the comonomer derived from C₃ to C₂₀ α-olefins, e.g. 1-butene or 1-hexene, and in some embodiments is a homopolymer of ethylene. In various embodiments, a density of the HDPE is from 0.94 g/cm³ to 0.97 g/cm³, such as from about 0.945 g/cm³ to about 0.965 g/cm³, or from about 0.95 g/cm³ to about 0.965 g/cm³. The HDPE may have a melt index (MI) of about 0.1 g/10 min, 0.2 g/10 min, or 0.4 g/10 min to about 4 g/10 min, 6 g/10 min, or 10 g/10 min. The HDPE may be prepared with either Ziegler-Natta or chromium-based catalysts in slurry reactors, gas phase reactors, or solution reactors.

In some embodiments, HDPEs of the present disclosure (and methods of making HDPEs) can be those described in U.S. Patent Publication No. 2017/0233507, incorporated herein by reference, which describes HDPEs formed using zirconium-based metallocene catalysts.

In some embodiments, an HDPE may have a density of at least about 0.950 g/cm³ and a MI, I_{2.16}, of less than about 1 g/10 min. The HDPE may further have at least one of the following properties: (i) a melting point of at least about 125° C.; (ii) a molecular weight distribution (MWD) of about 7 to about 20; and (iii) a melt index ratio (MIR), I_{21.6}/I_{2.16}, of about 45 to about 75.

In some embodiments, an HDPE may have: (i) a density of about 0.950 g/cm³ to about 0.960 g/cm³; (ii) an MI, I_{2.16}, of about 0.15 to about 0.8; (iii)-a melting point of about 125° C. to about 135° C.; (v) an MWD of about 8 to about 15; and (iv) an MIR, I_{21.6}/I_{2.16}, of about 55 to about 70.

In some embodiments, an HDPE has a density of at least about 0.950 g/cm³, such as about 0.950 g/cm³ to about 0.970 g/cm³, such as about 0.950 g/cm³ to about 0.960 g/cm³, such as about 0.953 g/cm³ to about 0.958 g/cm³, as determined by ASTM D1505 using a density-gradient column on a compression-molded specimen that has been slowly cooled to room temperature (i.e., over a period of 10 minutes or more) and allowed to age for a sufficient time that the density is constant within +/−0.001 g/cm³.

In some embodiments, an HDPE has an MI, I_{2.16}, of less than about 1.5 g/10 min, such as about 0.1 to about 0.9 g/10 min, such as about 0.4 to about 0.8 g/10 min, as measured by ASTM D1238 (190° C., 2.16 kg).

In some embodiments, an HDPE has one or more of the following properties:
1. a Vicat softening temperature of about 110° C. to about 140° C., such as about 120° C. to about 130° C., such as about 125° C. to about 128° C., as determined by ASTM D1525; and/or
2. a tensile strength at break (MD) of about 8,000 psi to about 10,000 psi, such as about 8,500 psi to about 9,000 psi, such as about 8,700 psi, as determined by ASTM D882-10; and/or
3. a tensile strength at break (TD, 20 in/min) of about 3,500 psi to about 5,500 psi, such as about 4,250 psi to about 4,750 psi, such as about 4,500 psi, as determined by ASTM D882-10; and/or
4. an elongation at break (MD, 20 in/min) of about 400% to about 600%, such as about 475% to about 525%, such as about 510%, as determined by ASTM D882; and/or
5. an elongation at break (TD, 20 in/min) of about 0.5% to about 5%, such as about 1% to about 3%, such as about 2%, as determined by ASTM D882; and/or
6. a secant modulus MD (1% secant) of about 125,000 psi to about 250,000 psi, such as about 150,000 psi to about 200,000 psi, such as about 160,000 psi to about 180,000 psi, such as about 170,000 psi, as determined by ASTM D882; and/or
7. a secant modulus TD (1% secant) of about 150,000 psi to about 450,000 psi, such as about 200,000 psi to about 400,000 psi, such as about 225,000 psi to about 275,000 psi, such as about 250,000 psi, as determined by ASTM D882; and/or
8. a dart drop impact of about 30 grams or less, as determined by ASTM D1709A; and/or
9. an Elmendorf Tear Strength (MD) of about 3 g to about 20 g, such as about 5 g to about 15 g, such as about 8 g to about 12 g, such as about 9 g to about 11 g, such as about 10 g, as determined by ASTM D1922; and/or
10. an Elmendorf Tear Strength (TD) of about 150 g to about 250 g, such as about 175 g to about 225 g, such as about 190 g to about 210 g, such as about 200 g, as determined by ASTM is D1922.

It will be realized that the HDPE described herein can be utilized alone or admixed with other polyethylene polymers of the class described herein in order to obtain desired properties. In some embodiments, the HDPE is an ethylene homopolymer.

The HDPE described herein can be formed using any of the conventional process known in the art for producing HDPE, such as gas phase, solution or slurry polymerization conditions. A stirred polymerization reactor can be utilized for a batch or continuous process, or the reaction can be carried out continuously in a loop reactor.

In some embodiments, the polymerization occurs in a slurry loop reactor under slurry polymerization conditions. One of ordinary skill in the art, in possession of the present disclosure, can determine the appropriate slurry polymerization conditions. Loop reactors are known in the art, see, for example, U.S. Pat. Nos. 3,248,179; 4,424,341; 4,501,855; 4,613,484; 4,589,957; 4,737,280; 5,597,892; 5,575,979; 6,204,344; 6,281,300; 6,319,997; and 6,380,325.

Chromium-based catalysts, such as those modified with aluminum alkyls, are known for polymerization in slurry reactions and may be suitable for making the HDPE. See, for instance, U.S. Patent Publication No. 2020/0055966 for discussion of some suitable chromium catalysts. In other embodiments, in connection with slurry, gas phase, or other polymerization, the HDPE can be made using any suitable metallocene catalyst.

Suitable commercial polymers for an HDPE may include those sold by ExxonMobil Chemical Company in Houston Tex., including HDPE HD and HDPE HTA and those sold under the trade names PAXON™ (ExxonMobil Chemical Company, Houston, Texas, USA); CONTINUUM™, DOW™, DOWLEX™, and UNIVAL™ (The Dow Chemical Company, Midland, Michigan, USA). Commercial HDPE is available with a density range such as 0.94 g/cm³ to 0.97 g/cm³ and melt index (MI) range such as 0.06 g/10 min. to 33 g/10 min. HDPE polymers may include:
ExxonMobil™ HDPE HTA 108 resin has an MI of 0.70 g/10 min and density of 0.961 g/cm³, and is commercially available from ExxonMobil Chemical Company, Houston, Texas.
PAXON™ AA60-003 resin has an MI of 0.25 g/10 min and density of 0.963 g/cm³, and is commercially available from ExxonMobil Chemical Company, Houston, Texas.
CONTINUUM™ DMDA-1260 resin has an MI of 2.7 g/10 min and density of 0.963 g/cm³, and is commercially available from Dow Chemical Company, Midland, Michigan.
UNIVAL™ DMDA-6147 resin has an MI of 10 g/10 min and density of 0.948 g/cm³, and is commercially available from Dow Chemical Company, Midland, Michigan.

### Second Polyethylenes

Blends of the present disclosure (and films thereof) include a second polyethylene in addition to the high density polyethylene (the first polyethylene).

In some embodiments, the second polyethylene may be a polyethylene homopolymer and/or copolymer of ethylene and one, two, three, four or more C₃ to C₄₀ olefin comonomers, for example, C₃ to C₂₀ α-olefin comonomers.

For example, the second polyethylene may include a copolymer of ethylene and one, two, or three or more different C₃ to C₄₀ olefins (comonomers). In some embodiments, the second polyethylene includes a majority of units derived from polyethylene, and a minority of units derived from one or more C₃ to C₄₀ comonomers, such as C₃ to C₂₀ α-olefin comonomers (e.g., propylene, 1-butene, 1-hexene, 1-octene, 1-decene, 1-dodecene, such as propylene, 1-butene, 1-hexene, 1-octene, or a mixture thereof; such as 1-butene and/or 1-hexene).

The second polyethylene may include the ethylene-derived units in an amount of at least 80 wt %, or 85 wt %, such as at least 90, 93, 94, 95, or 96 wt % (for instance, in a range from a low of 80, 85, 90, 91, 92, 93, 94, 95, 96, or 97 wt %, to a high of 94, 95, 95.5, 96, 96.5, 97, 97.5, or 98 wt %, with ranges from any foregoing low value to any foregoing high value contemplated, provided the high is greater than the low) based on a total amount of ethylene-derived units and comonomer-derived units. For instance, the second polyethylene may include 94 or 95 wt % to 97 or 98 wt % ethylene-derived units based on the total amount of ethylene-derived units and comonomer-derived units. Comonomer units (e.g., C₂ to C₂₀ α-olefin-derived units, such as units derived from butene, hexene, and/or octene) may be present in the second polyethylene from a low of 2, 2.5, 3, 3.5, 4, 4.5, 5, or 6 wt %, to a high of 3, 4, 5, 6, 7, 8, 9, 10, 15, or 20 wt %, with ranges from any foregoing low to any foregoing high contemplated (provided the high is greater than the low value) based on a total amount of ethylene-derived units and comonomer-derived units. For instance, the second polyethylene may include 2, 2.5, or 3 wt % to 5 or 6 wt % comonomer units based on a total amount of ethylene-derived units and comonomer-derived units.

Several suitable comonomers were already noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octene as already noted), and α-olefins having one or more C₁-C₃ alkyl branches, or an aryl group. Examples can include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

### Second Polyethylene—Molecular Characteristics

The second polyethylene according to various embodiments can have a density of about 0.91 to about 0.950 g/cm³, such as about 0.914 to about 0.935 g/cm³. For example, second polyethylenes may have a density from a low of any one of 0.9, 0.91, 0.911, 0.912, 0.913, 0.914, 0.915, 0.916, 0.917, 0.918, 0.919, 0.92, 0.921, or 0.922 g/cm³ to a high of any one of 0.945, 0.944, 0.943, 0.942, 0.941, 0.940, 0.939, 0.938, 0.937, 0.936, 0.935, 0.934, 0.933, 0.932, 0.931, 0.930, 0.929, 0.928, or 0.927 g/cm³, with ranges of various embodiments including any combination of any upper or lower value disclosed herein (e.g., 0.919 to 0.927). Density herein is measured by displacement method according to ASTM D1505. Alternatively, density can be greater than any one of the foregoing low ends, and/or less than any one of the foregoing high ends, such as within the range from greater than 0.918 g/cm³ to 0.927 g/cm³.

In various embodiments, the second polyethylene has one or more, two or more, three or more, four or more, such as all, of the following molecular weight properties:
weight-average molecular weight (Mw) of about 50,000 to about 300,000, such as from a low value of any one of 90,000 g/mol; 100,000 g/mol; 110,000 g/mol; 115,000 g/mol; 120,000 g/mol; 125,000; and 130,000 g/mol, to a high value of any one of 125,000 g/mol, 130,000 g/mol, 135,000 g/mol, 140,000 g/mol, 145,000 g/mol; 150,000 g/mol; 155,000 g/mol; 160,000 g/mol; 170,000 g/mol; 180,000 g/mol; 190,000 g/mol; 200,000 g/mol; 210,000 g/mol; 225,000 g/mol; and 250,000 g/mol. Ranges from any one of the foregoing low values to any one of the foregoing high values are contemplated in various embodiments, provided the high value is greater than the low value. For example, Mw can be about 90,000 to about 170,000 g/mol or about 115,000 to about 160,000 g/mol, such as about 115,000 g/mol to about 125,000 g/mol.
number-average molecular weight (Mn) of about 7,000 to about 40,000 g/mol, such as from a low value of any one of 15,000 g/mol; 16,000 g/mol; 17,000 g/mol; 18,000 g/mol; 19,000 g/mol, and 20,000 g/mol to a high value of any one of 19,000 g/mol, 20,000 g/mol, 22,000 g/mol, 25,000 g/mol; 26,000 g/mol; 27,000 g/mol; 28,000 g/mol; 29,000 g/mol; 30,000 g/mol, 35,000 g/mol; 40,000 g/mol, and 50,000 g/mol. Ranges from any one of the foregoing low values to any one of the high values are contemplated in various embodiments (for instance, Mn may be about 15,000 g/mol to about 50,000 g/mol, such as about 15,000 to about 25,000 g/mol, such as about 17,000 g/mol to about 19,000 g/mol).
Z-average molecular weight (Mz) of about 200,000 to about 500,000 g/mol, such as 250,000 g/mol, 275,000 g/mol, 300,000 g/mol, 325,000 g/mol, and 350,000 g/mol to a high value of any one of 325,000 g/mol, 350,000 g/mol, 375,000 g/mol, 400,000 g/mol; 450,000 g/mol; 500,000 g/mol; 550,000 g/mol; 600,000 g/mol; 650,000 g/mol; and 700,000 g/mol. Ranges from any one of the foregoing low values to any one of the high values are contemplated in various embodiments (for instance, Mz may be about 200,000 g/mol to about 400,000 g/mol, such as about 250,000 g/mol to about 350,000 g/mol, such as about 275,000 g/mol to about 325,000 g/mol.

The second polyethylene in accordance with various embodiments can have Mw/Mn value (sometimes also referred to as polydispersity index, PDI) of a low of 3, 3.5, 4, 4.5, 5, 5.5, 6, 6.1, 6.2, 6.3, 6.4, 6.5, 6.6, 6.7, 6.8, 6.9, or 7 to a high of 5.5, 5.7, 6, 6.1, 6.2, 6.3, 6.4, 6.5, 6.6, 6.7, 6.8, 6.9, 7, 7.5, 8, 8.5, 9, 9.5, 10, 11, or 12 (with ranges from any low value to any high value contemplated, such as Mw/Mn of about 4 to about 12, such as about 5.5 to 8, such as about 6.5 to about 7).

A second polyethylene may have an Mz/Mw value of 1, 1.5, 2, 2.1, 2.2, 2.3, 2.4, or 2.5 to 2.6, 2.7, 2.8, 2.9, 3, 3.25, 3.5, 4.0, 4.5, 5.0, 5.5, or 6.0 (with ranges from any low value to any high value contemplated, such as Mz/Mw of about 2 to about 3, such as about 2.3 to about 2.7, such as about 2.4 to about 2.6).

A second polyethylene may have an Mz/Mn value of 10, 12, 14, 15, 16, 16.2, 16.4, 16.6, 16.7, 16.8, 16.9, 17 or 17.2 to 22, 20, 18, 17.8, 17.6, 17.5, 17.4, 17.3, 17.2, 17.1, or 17 (with ranges from any low value to any high value contemplated, such as Mz/Mn of about 16.5 to about 17.4, such as about 16.7 to about 17.2, such as about 16.7 to about 16.9, alternatively about 17 to about 17.2).

The distribution and the moments of molecular weight (Mw, Mn, Mz, Mw/Mn, Mz/Mn, etc.) and the monomer/comonomer content (C₂, C₄, C₆ and/or Cs, and/or others, etc.) of a second polyethylene of the present disclosure are determined by using a high temperature Gel Permeation Chromatography (Polymer Char GPC-IR) equipped with a multiple-channel band-filter based Infrared detector IR5, an 18-angle light scattering detector and a viscometer. Three Agilent PLgel 10 μm Mixed-B LS columns are used to provide polymer separation. Detailed analytical principles and methods for molecular weight determinations are described in paragraphs [0044]-[0051] of PCT Publication WO2019/246069A1, which are herein incorporated by reference (noting that the equation c=/// referenced in Paragraph [0044] therein for concentration (c) at each point in the chromatogram, should properly read c=1, where β is mass constant and I is the baseline-subtracted IR5 broadband signal intensity (I)). Unless specifically mentioned, all the molecular weight moments used or mentioned in the present disclosure are determined according to the conventional molecular weight (IR molecular weight) determination methods (e.g., as referenced in Paragraphs [0044]-[0045] of PCT Publication WO2019/246069A1), noting that for the equation in such Paragraph [0044], a=0.695 and K=0.000579(1−0.75Wt) are used, where Wt is the weight fraction for comonomer, and further noting that comonomer composition is determined by the ratio of the IR5 detector intensity corresponding to CH₂ and CH₃ channel calibrated with a series of PE and PP homo/copolymer standards whose nominal values are predetermined by NMR or FTIR (providing methyls per 1000 total carbons (CH₃/1000 TC)) as noted in Paragraph [0045] of PCT Publication WO2019/246069A1). Other parameters needed can be found in the referenced passage in the WO2019/246069A1 publication, but some are included here for convenience: n=1.500 for TCB at 145° C.; I=665 nm; dn/dc=0.1048 ml/mg.

### Composition Distribution

As noted, a second polyethylene of the present disclosure exhibits BOCD characteristics. Several methods can illustrate the high degree of preferential comonomer incorporation along the high molecular-weight chains of the second polyethylene. For example, the polyethylene composition may have the same BOCD characteristics for embodiments described in (and determined in the same manner as detailed in) Paragraphs [0051]-[0055] and [0160] of WO2019/083609, the description of which is incorporated by reference herein. This includes a T₇₅−T₂₅ value in accordance with the embodiments described in Paragraphs [0051]-[0055], an M₆₀/M₉₀ value in accordance with those in Paragraph [0054], and/or an F₈₀ value per Paragraph [0055] of said reference, as determined by the TREF-LS method described therein.

The breadth of the composition distribution can be characterized by the T₇₅−T₂₅ value, wherein T₂₅ is the temperature at which 25% of the eluted polymer is obtained and T₇₅ is the temperature at which 75% of the eluted polymer is obtained in a TREF experiment as is described in WO2019/083609. The composition distribution is further characterized by the F₈₀ value, which is the fraction of polymer that elutes below 80° C. in a TREF-LS experiment as described herein. A higher F₈₀ value indicates a higher fraction of comonomer in the polymer molecule.

An orthogonal composition distribution is defined by a M₆₀/M₉₀ value that is greater than 1, wherein M₆₀ is the molecular weight of the polymer fraction that elutes at 60° C. in a TREF-LS experiment and M₉₀ is the molecular weight of the polymer fraction that elutes at 90° C. in a TREF-LS experiment as described herein.

The second polyethylene as described herein can have a BOCD characterized in that the T₇₅−T₂₅ value is 1 or greater, 2 or greater, 2.5 or greater, 4 or greater, 5 or greater, 7 or greater, 10 or greater, 11.5 or greater, 15 or greater, 17.5 or greater, 20 or greater, 25 or greater, or greater, 35 or greater, 40 or greater, or 45 or greater, wherein T₂₅ is the temperature at which 25% of the eluted polymer is obtained and T₇₅ is the temperature at which 75% of the eluted polymer is obtained in a TREF experiment as described in WO2019/083609.

The second polyethylene as described herein may also or instead have a BOCD characterized in that M₆₀/M₉₀ value is 1.5 or greater, 2 or greater, 2.25 or greater, 2.5 or greater, 3 or greater, 3.5 or greater, 4 or greater, 4.5 or greater, or 5 or greater, to about 20, such as to about 10, wherein M₆₀ is the molecular weight of the polymer fraction that elutes at 60° C. in a TREF-LS experiment and M₉₀ is the molecular weight of the polymer fraction that elutes at 90° C. in a TREF-LS experiment as described in.

Another means of characterizing BOCD, as noted, is F₈₀ (the fraction (wt %) of polymer that elutes below 80° C. in the TREF-LS experiment). Thus, the polymers as described herein may further have a BOCD characterized in that F₈₀ value is 10% or greater, 2% or greater, 3% or greater, 4% or greater, 5% or greater, 6% or greater, 7% or greater, 10% or greater, 11% or greater, 12% or greater, or 15% or greater.

Yet a further way to help characterize the BOCD nature of the second polyethylene is composition distribution breadth index (CDBI). CDBI is determined as described in the examples below, and for the second polyethylene may be within the range from about 20% to about 50%, such as from w a low of any one of about 25%, 30%, or 35% to a high of any one of about 33%, 35%, 39%, 40%, or 45% (with ranges from any foregoing low to any foregoing high contemplated herein).

In addition, TREF elution procedures as described in connection with the Examples section below can be used to determine: (1) very low density, (2) low density, (3) medium density, and (4) high density contents (in terms of wt %) of the second polyethylene, wherein is the total of all four of these fractions adds up to 100 wt % based on total amount of polymer eluting in the TREF procedure:
a very low density content of about 17% to about 35%, such as about 20% to about 30%, such as about 19% to about 28%, (as determined by the TREF elution procedure described below in the Examples section);
a low density content of about 15% to about 25%, such as about 18% to about 25%, such as about 19% to about 23%, (as determined by the TREF elution procedure described below in the Examples section);
a medium density content of about 18% to about 30%, such as about 20% to about 25%, (as determined by the TREF elution procedure described below in the Examples section);
a high density content of about 20% to about 45%, such as about 20% to about 40%, alternatively about 25% to about 40%, such as about 27% to about 39%.

### Other Rheological Properties

In various embodiments, the second polyethylene has a melt index, (MI, also referred to as I₂ or I_{2.16} in recognition of the 2.16 kg loading used in the test) within the range from 0.1 g/10 min to 5 g/10 min, such as from a low of any one of 0.1, 0.2, 0.3, 0.4 g/10 min, to a high of 0.5, 0.55, 0.6, 0.65, 0.7, 0.75, 0.85, 0.9, 0.95, 1, 1.2, 1.5, 1.7, 2, 3, 4, 5, or 10 g/10 min, with ranges from any of the foregoing low values to any of the foregoing high values contemplated herein) (e.g., about 0.1 to about 1 g/10 min, such as about 0.6 to about 0.9 g/10 min, such as about 0.6 to about 0.7, alternatively about 0.85 to about 0.95). Moreover, the second polyethylene of various embodiments can have a high load melt index (HLMI) (also referred to as I₂₁ or I_{21.6} in recognition of the 21.6 kg loading used in the test) from a low of 10, 15, 20, 25, 30, 35, 40, 45, 50, or 55 g/10 min to a high of 80, 75, 70, 65, 60, or 55 g/10 min; s with ranges from any of the foregoing lows to any of the foregoing highs contemplated herein (e.g., about 15 to about 30 g/10 min, such as about 16 to about 19 g/10 min, alternatively about 23 g/10 min to about 27 g/10 min.

Second polyethylenes according to various embodiments may have a melt index ratio (MIR, defined as I_{21.6}/I_{2.16}) within the range from a low of any one of 10, 15, 20, 21, 22, 23, 24, 25, 26, 26.5, 27, 27.5, 28, or 28.5 to a high of any one of 27.5, 28, 28.5, 29, 30, 31, 32, 33, 34, 35, 40, 45, or 50, such as from any of the foregoing lows to any of the foregoing highs contemplated herein (e.g., about 20 to about 35, such as about 26 to about 28, alternatively about 28 to about 30).

Melt index (2.16 kg) and high-load melt index (HLMI, 21.6 kg) values can be is determined according to ASTM D1238-13 procedure B, such as by using a Gottfert MI-2 series melt flow indexer. For MI, HLMI, and MIR values reported herein, testing conditions are set at 190° C. and 2.16 kg (MI) and 21.6 kg (HMLI) load.

In particular embodiments, the second polyethylene may be characterized by a combination of rheological and microstructural parameters—in particular, by the ratio of its MIR (rheological parameter) to its Mw/Mn (microstructural parameter) as determined by GPC. Both the MIR and Mw/Mn values provide information about the molecular weight distribution of the polymer chains that make up the polymer composition. However, MIR can be more sensitive to features of the polymer chains that impact the composition's rheology; Mw and Mn as determined by GPC, on the other hand, may not be as sensitive to rheological features of the polymer chains. So, when the two provide substantially different answers, e.g., in the case of a higher ratio of MIR to Mw/Mn, one can infer a greater degree of long-chain branching or similar structural features of the polymer chains that would impact rheology, but not necessarily molecular weight distribution. On the other hand, a lower MIR to Mw/Mn ratio would indicate a lesser degree of long-chain branching and/or other structural features of the polymer chains that would impact rheology. Accordingly, the second polyethylene of various embodiments herein may have a ratio of MIR to Mw/Mn, which is referred to as “MIR/(Mw/Mn)” of less than 6, such as less than 5, such as 4.5 or less, such as 4.3 or less, such as 4 or less. Alternatively, the MIR/(Mw/Mn) may be from a low of 3.5, 3.6, 3.7, 3.8, 3.9, 4, or 4.1 to a high of 3.8, 3.9, 4, 4.1, 4.2, 4.3 or 4.4, with ranges from any foregoing low value to any foregoing high value contemplated (e.g., about 3.5 to about 4.3, such as about 3.8 to about 4.2, such as about 4 to about 4.2).

Furthermore, in various embodiments, the second polyethylene exhibits shear-thinning rheology, meaning that for increasing shear rates, viscosity decreases. This rheology indicates good processability for the second polyethylene in accordance with such embodiments (insofar as the shear rates simulate the viscosity that the composition may exhibit when processed in extruders or similar equipment). The second polyethylene can show desired shear-thinning very similar to comparative resins, showing that the improved strength properties resulting from the highly BOCD nature of the present second polyethylenes can be achieved without sacrificing processability.

Put quantitatively, a second polyethylene according to various embodiments may exhibit one or more, two or more, or even all, of the following rheological properties:
Degree of shear thinning, DST, of about 0.6 to about 0.98, such as about 0.65 to about 0.95, with ranges from any foregoing low to any foregoing high contemplated herein. DST is a measure of shear-thinning rheological behavior (decreasing viscosity with increasing shear rate), and defined as DST=[η*(0.01 rad/s)−η*(100 rad/s)]/η*(0.01 rad/s), where η*(0.01 rad/s) and η*(100 rad/s) are the complex viscosities at 0.01 and 100 rad/s, respectively.
Complex viscosity (at 628 rad/s, 170° C.) of about 400 to about 1,400 Pa*s, such as about 600 to about 1,000 Pa*s.
Complex viscosity (at 100 rad/s, 170° C.) of about 2,000 to about 4,000 Pa*s, such as about 2,400 to about 3,100 Pa*s.
Complex viscosity (at 0.01 rad/s, 170° C.) of about 15,000 to about 45,000 Pa*s, such as about 20,000 to about 35,000 Pa*s.

Rheological data such as complex viscosity can be determined using SAOS (small amplitude oscillatory shear) testing. SAOS experiments are performed at 170° C. using a 25 mm parallel plate configuration on an ARES-G2 (TA Instruments). Sample test disks (25 mm diameter, 2 mm thickness) are made with a Carver Laboratory press at 170° C. Samples are allowed to sit without pressure for approximately 3 minutes in order to melt and then held under pressure typically for 3 minutes to compression mold the sample. The disk sample are first equilibrated at 170° C. for about 10 minutes between the parallel plates in the rheometer to erase any prior thermal and crystallization history. An angular frequency sweep is next performed with a typical measurement gap of 1.5 mm from 628 rad/s to 0.01 rad/s angular frequency using points/decade and a strain value within the linear viscoelastic region determined from strain sweep experiments (see C. W. Macosko, Rheology Principles, Measurements and Applications, Wiley-VCH, New York, 1994). All experiments are performed in a nitrogen atmosphere to minimize any degradation of the sample during the rheological testing.

### Other Physical Properties of Second Polyethylenes

As discussed previously, second polyethylenes in accordance with various embodiments described herein can exhibit highly advantaged physical properties, enabling an excellent balance of flexibility while maintaining good strength properties. These physical properties of the second polyethylenes can include, but are not limited to, one or more of the following
1. a secant modulus TD (1% secant) of about 35,000 psi to about 50,000 psi, such as about 40,000 psi to about 45,000 psi, as determined by ASTM D882; and/or
2. a dart drop impact of about 300 g/mil to about 800 g/mil, such as about 300 g/mil to about 400 g/mil, alternatively about 700 g/mil to about 800 g/mil, as determined by ASTM D1709A; and/or
3. an Elmendorf Tear Strength (MD) of about 150 g/mil to about 350 g/mil, such as about 200 g/mil to about 250 g/mil, as determined by ASTM D1922

### Methods of Making Second Polyethylenes

Polymerization processes according to the present disclosure can be carried out in any suitable manner. Any suitable suspension, slurry, high pressure tubular or autoclave process, or gas phase polymerization process can be used under polymerizable conditions. Such processes can be run in a batch, semi-batch, or continuous mode. Heterogeneous polymerization processes (such as gas phase and slurry phase processes) are useful. A heterogeneous process is defined to be a process where the catalyst system is not soluble in the reaction media. Alternatively, in other embodiments, the polymerization process is not homogeneous.

Monomer (such as ethylene), and optionally comonomer (e.g., any of the above-described comonomers of the second polyethylene), are contacted with a catalyst system comprising at least one activator, at least one support, and at least one catalyst, such as a metallocene compound. The support, catalyst, and activator may be combined in any order, and are combined typically prior to contacting with the monomers.

In various embodiments, the polymerization processes as described generally in paragraphs [0104]-[0114] of WIPO Publication WO2019/083609, which description is incorporated by reference herein, may be suitable (e.g., gas-phase or slurry-phase processes as described therein).

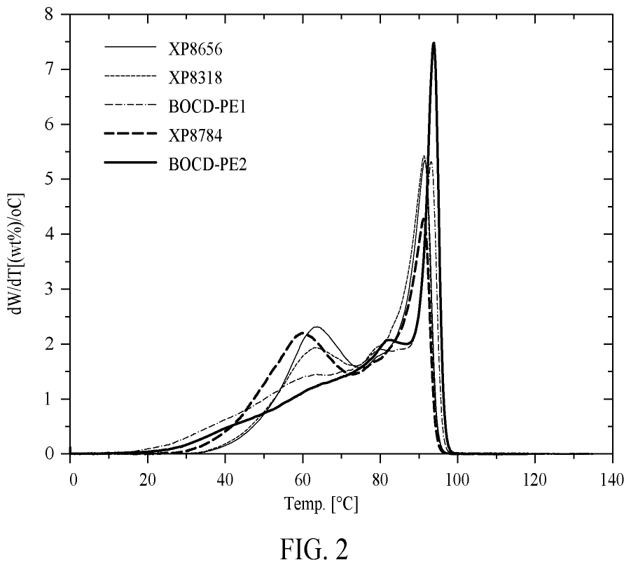

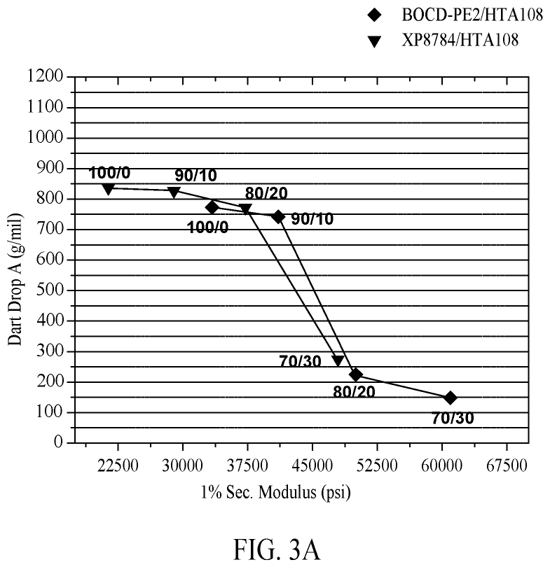

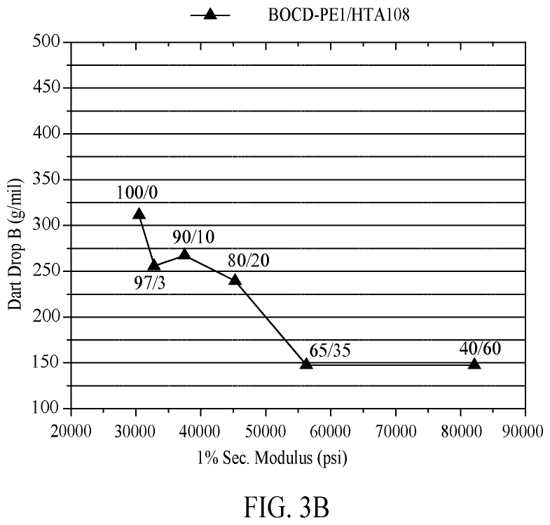

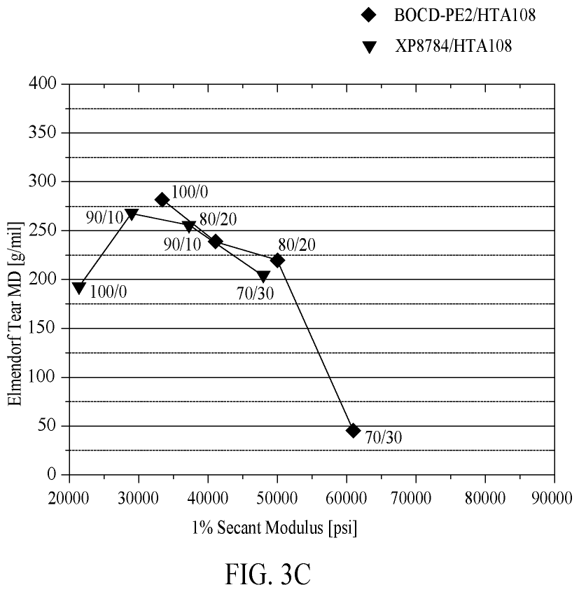

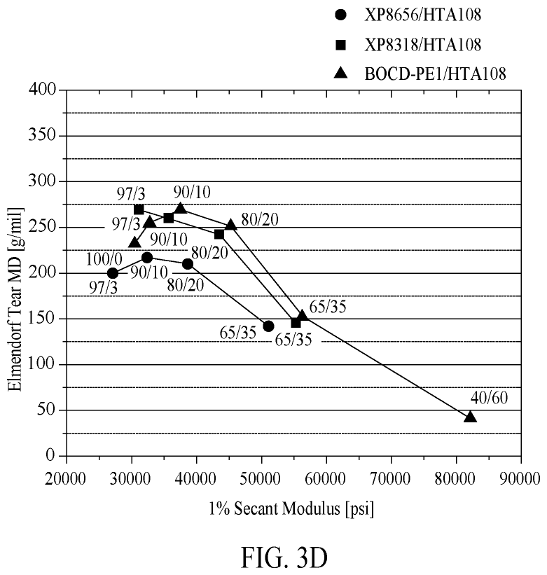

In some embodiments, the polymerization is performed in the gas phase, in particular in a gas-phase fluidized bed reactor system in accordance with the general description of Paragraphs [0172]-[0178] and FIG. 2 of US Patent Publication No. US 2020/0071437, which description and figure are incorporated by reference herein. Furthermore, a catalyst system comprising two catalyst compositions (as described below) may be used, and delivered to the fluidized bed reactor as a catalyst component solution and catalyst component slurry combined and delivered as described in the systems and processes in US2020/0071437, Paragraphs [0145]-[0171] and FIGS. 2 and 3, which description is also incorporated herein by reference.

The polymerization to obtain the second polyethylenes can take place in a single reactor, or in multiple parallel reactors with post-reactor blending, as opposed to taking place in multiple series reactors. However, it is also contemplated that the second polyethylene could, in other embodiments, be formed in multiple (two or more) series reactors.

Catalyst Systems and Activators for forming Second Polyethylenes

As noted, suitable polymerization processes employ a polymerization catalyst system, and in particular a polymerization catalyst system comprising at least one activator, at least one support and at least one catalyst composition. The catalyst composition is preferably a single-site catalyst, such as a metallocene catalyst.

Any suitable polymerization catalyst may be used to obtain the polyethylene compositions as described herein (e.g., Ziegler-Natta, single-site such as metallocene, etc.), but preferred catalyst systems employ a catalyst system comprising a mix of two metallocene catalysts: a bis-cyclopentadienyl hafnocene and a zirconocene, such as an indenyl-cyclopentadienyl zirconocene.

More particularly, the bis-cyclopentadienyl hafnocene may be in accordance with one or more of the following metallocene catalyst compositions according to formulas (Al) and/or (A2) as described in US2020/0071437; and the zirconocene may be in accordance with one or more of the catalyst compositions of formula (B) as described in US2020/0071437. Further, the catalyst system may be delivered to the polymerization reactor (e.g., gas phase fluidized bed polymerization reactor; slurry loop polymerization reactor, or other suitable reactor) in a catalyst trim methodology as described in paragraphs [0134]-[0139] of US2020/0071437. Further, any of the activators and/or supports and other catalyst additives as described in US2020/0071437 may be employed in connection with the catalyst system.

### Blends

Embodiments of the present disclosure also generally relate to blends of high density polyethylene with the second polyethylene (having a density of greater than 0.918 g/cm³) prior to being formed into a film, molded part or other article. The blends may optionally further include one or more additional polymers (e.g., a third polyethylene). For example, additional polymers may include a polyethylene, an isotactic polypropylene, a highly isotactic polypropylene, a syndiotactic polypropylene, a random copolymer of propylene and ethylene, and/or butene, and/or hexene, polybutene, ethylene vinyl acetate, LDPE, LLDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, is poly-1 esters, polyacetal, polyvinylidine fluoride, polyethylene glycols, and/or polyisobutylene.

In at least one embodiment, the second polyethylene is present in the above blends, at about 10 wt % to about 99 wt %, based upon the total weight of the polymers in the blend, such as about 20 wt % to about 95 wt %, such as about 30 wt % to about 90 wt %, such as about 40 wt % to about 90 wt %, such as about 50 wt % to about 90 wt %, such as about 60 wt % to about 90 wt %, such as about 70 to about 90 wt %, such as about 80 to about 90 wt %, alternatively about 90 to about 99 wt %, such as about 92 to about 98 wt %.

The blends described above may be produced by mixing the polymers of the present disclosure with one or more polymers (as described above), by connecting reactors together in series or in parallel to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

A blend according to various embodiments can have an average Raman density of about 0.91 to about 0.950 g/cm³, such as about 0.921 to about 0.924 g/cm³. For example, blends may have a density from a low of any one of 0.91, 0.911, 0.912, 0.913, 0.914, 0.915, 0.916, 0.917, 0.918, 0.919, 0.92, 0.921, or 0.922 g/cm³ to a high of any one of 0.945, 0.944, 0.943, 0.942, 0.941, 0.940, 0.939, 0.938, 0.937, 0.936, 0.935, 0.934, 0.933, 0.932, 0.931, or 0.930 g/cm³, with ranges of various embodiments including any combination of any upper or lower value disclosed herein. Average Raman density is measured by using CRM-Alpha 300 is Confocal Raman microscope which can determine the crystallinity and density of polyethylene samples. The method is based on peak fitting and normalization procedures to obtain the orthorhombic crystalline, anisotropic disorder and isotropic amorphous phases. These procedures are based on Strobl et al. publication (Raman spectroscopic method for determining the crystallinity of polyethylene; Journal of Polymer Science: Polymer Physics Edition, 1978, 16, 1181-1193). Once, all-trans conformer and amorphous conformer mass fractions are determined, the average Raman density is calculated assuming a two-phase system: crystalline phase with a density of 1.004 g/cm³ and amorphous phase with a density of 0.853 g/cm³, see equation (I):

$$Density = \frac{1}{\frac{all - trans}{1.004 g / {cm}^{3}} + \frac{amorphous}{0.8 \; 53 g / {cm}^{3}}} \qquad ( I )$$

More details are reported in the literature as Lagaron et al. (Morphological characterization of the crystalline structure of cold-drawn HDPE used as a model material for the environmental stress cracking (ESC) phenomenon; Polymer, 1999, 40, 2569-2586) and Encyclopedia of Polymer Science and Engineering (Crystallinity Determination, 1989, 482-487).

A blend according to various embodiments can have a sigma T (“σ_{T}(° C.)”) of about 12 to about 20, such as about 12.5 to about 18, such as about 13 to about 17.5, such as about 13.5 to about 17.5, such as about 14 to about 17.5, such as about 14.5 to about 17, such as about to about 17, such as about 15.5 to about 17, such as about 15 to about 16, alternatively about 16 to about 17, with ranges of various embodiments including any combination of any upper or lower value disclosed herein. Sigma T herein is measured by the method described below in the Examples section.

In various embodiments, the blend has one or more, two or more, such as all, of the following molecular weight properties:
a very low density content of about 17% to about 35%, such as about 20% to about 30%, such as about 19% to about 28%, (as determined by the TREF elution procedure described below in the Examples section).
a low density content of about 10% to about 25%, such as about 15% to about 20%, alternatively about 20% to about 23%, (as determined by the TREF elution procedure described below in the Examples section).
a medium density content of about 10% to about 25%, such as about 10% to about 19%, alternatively about 19% to about 22%, (as determined by the TREF elution procedure described below in the Examples section).
a high density content of about 20% to about 70%, such as about 25% to about 35%, alternatively about 40% to about 50%, alternatively about 50% to about 60%, (as determined by the TREF elution procedure described below in the Examples section).
weight-average molecular weight (Mw) of about 50,000 to about 300,000, such as from a low value of any one of 90,000 g/mol; 100,000 g/mol; 110,000 g/mol; 115,000 g/mol; 120,000 g/mol; 125,000; and 130,000 g/mol, to a high value of any one of 125,000 g/mol, 130,000 g/mol, 135,000 g/mol, 140,000 g/mol, 145,000 g/mol; 150,000 g/mol; 155,000 g/mol; 160,000 g/mol; 170,000 g/mol; 180,000 g/mol; 190,000 g/mol; 200,000 g/mol; 210,000 g/mol; 225,000 g/mol; and 250,000 g/mol. Ranges from any one of the foregoing low values to any one of the high values are contemplated in various embodiments, provided the high value is greater than the low value. For example, Mw can be about 90,000 to about 170,000 g/mol or about 115,000 to about 160,000 g/mol, such as about 115,000 g/mol to about 125,000 g/mol.
number-average molecular weight (Mn) of about 7,000 to about 40,000 g/mol, such as from a low value of any one of 15,000 g/mol; 16,000 g/mol; 17,000 g/mol; 18,000 g/mol; 19,000 g/mol, and 20,000 g/mol to a high value of any one of 19,000 g/mol, 20,000 g/mol, 22,000 g/mol, 25,000 g/mol; 26,000 g/mol; 27,000 g/mol; 28,000 g/mol; 29,000 g/mol; 30,000 g/mol, 35,000 g/mol; 40,000 g/mol, and 50,000 g/mol. Ranges from any one of the foregoing low values to any one of the high values are contemplated in various embodiments (for instance, Mn may be about 15,000 g/mol to about 50,000 g/mol, such as about 15,000 to about 25,000 g/mol, such as about 17,000 g/mol to about 19,000 g/mol).
Z-average molecular weight (Mz) of about 200,000 to about 900,000 g/mol, a low value such as 250,000 g/mol, 275,000 g/mol, 300,000 g/mol, 325,000 g/mol, 350,000 g/mol, 400,000 g/mol, and 600,000 g/mol to a high value of any one of 325,000 g/mol, 350,000 g/mol, 375,000 g/mol, 400,000 g/mol; 450,000 g/mol; 500,000 g/mol; 550,000 g/mol; 600,000 g/mol; 650,000 g/mol; and 700,000 g/mol. Ranges from any one of the foregoing low values to any one of the high values are contemplated in various embodiments (for instance, M_{z} may be about 200,000 g/mol to about 400,000 g/mol, alternatively about 400,000 g/mol to about 600,000 g/mol, alternatively about 600,000 g/mol to about 850,000 g/mol.
a CDBI of about 20% to about 50%, such as about 25% to about 40%, such as about is 30% to about 40%, such as about 30% to about 33%, alternatively about 35% to about 39%.

Furthermore, a blend in accordance with various embodiments may have Mw/Mn value (sometimes also referred to as polydispersity index, PDI) of a low value of 3, 3.5, 4, 4.5, 5, 5.5, 6, 6.1, 6.2, 6.3, 6.4, 6.5, 6.6, 6.7, 6.8, 6.9, or 7 to a high value of 5.5, 5.7, 6, 6.1, 6.2, 6.3, 6.4, 6.5, 6.6, 6.7, 6.8, 6.9, 7, 7.5, 8, 8.5, 9, 9.5, 10, 11, or 12 (with ranges from any low value to any high value contemplated, such as Mw/Mn of about 6 to about 8, alternatively about 8 to about 9).

A blend may have an Mz/Mw value of 1, 1.5, 2, 2.1, 2.2, 2.3, 2.4, or 2.5 to 2.6, 2.7, 2.8, 2.9, 3, 3.25, 3.5, 4, 4.5, 5, 5.5, 6, 6.5, or 7 (with ranges from any low value to any high value contemplated, such as Mz/Mw of about 2 to about 3, alternatively about 3 to about 4, alternatively about 4 to about 5, alternatively about 5 to about 6).

A blend may have an Mz/Mn value of 10, 12, 14, 15, 16, 16.2, 16.4, 16.6, 16.7, 16.8, 16.9, 17 or 17.2 to 40, 35, 30, 25, 22, 20, 18, 17.8, 17.6, 17.5, 17.4, 17.3, 17.2, 17.1, or 17 (with ranges from any low value to any high value contemplated, such as Mz/Mw of about 14 to about 18, such as about 15 to about 17, such as about 15 to about 16, alternatively about 16 to about 17).

### Films

Any of the foregoing blends (or second polyethylene without any HDPE content) may be used in a variety of end-use applications. Such applications include, for example, mono- or multi-layer blown, extruded, and/or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and/or longitudinal directions to the same or different extents. The uniaxially orientation can be accomplished using typical cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented is polyethylene could be coated onto polypropylene then optionally the combination could be oriented even further. For example, the films can be oriented in the Machine Direction (MD) at a ratio of up to 15, such as from about 5 to about 7, and in the Transverse Direction (TD) at a ratio of up to 15, such as from about 7 to about 9. However, in some embodiments the film is oriented to the same extent in both the MD and TD directions.

The films may vary in thickness depending on the intended application; however, films of a thickness from about 1 μm to about 50 μm can be suitable. Films intended for packaging can be from about 10 μm to about 50 μm thick. The thickness of the sealing layer can be from about 0.2 Vim to about 50 m. There may be a sealing layer on both the inner and outer surfaces of the film or the sealing layer may be present on only the inner or the outer surface.

To facilitate discussion of different film structures, the following notation is used herein. Each layer of a film is denoted “A” or “B”. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer disposed between two outer layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film, for purposes described herein. The relative thickness of each film layer is similarly denoted, with the thickness of each layer relative to a total film thickness of about 100 (dimensionless) indicated numerically and separated by slashes; e.g., the relative thickness of an A/B/A′ film having A and A′ layers of about 10 μm each and a B layer of about 30 μm is denoted as 20/60/20.

In some embodiments, and using the nomenclature described above, the present disclosure provides for multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′B/B′″; (d) five-layer films, such as A/A′/A″/A′″/B, A/A′/A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B′″, B/B′/A/B″/B′″, and B/B′/B″/B′″/B″″; and similar structures for films having six, seven, eight, nine, twenty-four, forty-eight, sixty-four, one hundred, or any other number of layers. It should be appreciated that films can have still more layers.

In any of the embodiments above, one or more A layers can be replaced with a substrate layer, such as glass, plastic, paper, metal, etc., or the entire film can be coated or laminated onto a substrate. Thus, although the discussion herein has focused on multilayer films, the films may also be used as coatings for substrates such as paper, metal, glass, plastic, and any other suitable material.

In another embodiment, one or more layers may be modified by corona treatment, electron beam irradiation, gamma irradiation, flame treatment, or microwave. In at least one embodiment, one or both of the surface layers is modified by corona treatment.

### Film Properties

In some embodiments, the films are oriented in the Machine Direction (MD) at a draw down ratio of up to about 25 and a blow up ratio of about 2.5. The films may vary in thickness depending on the intended application; however, films of a thickness from about 1 m to about 150 m are usually suitable, such as from about 10 m to about 150 m. Films intended for packaging are usually about 10 m to about 70 μm thick and often consisted of co-extruded multilayers.

In at least one embodiment, a film of the present disclosure can have a 1% Secant Modulus in the Machine Direction (MD), according to ASTM D882-10 (25.4 mm width strip) of about 30,000 psi to about 90,000 psi, such as about 30,000 psi to about 40,000 psi, such as about 30,000 psi to about 35,000 psi, alternatively about 40,000 psi to about 50,000 psi, alternatively about 50,000 psi to about 60,000 psi, alternatively about 60,000 psi to about 70,000 psi, alternatively about 70,000 psi to about 85,000 psi. In at least one embodiment, a film of the present disclosure can have a 1% Secant Modulus in the Transverse Direction (TD), according to ASTM D882-10 (25.4 mm width strip) of about 40,000 psi to about 100,000 psi, such as about 40,000 psi to about 50,000 psi, alternatively about 50,000 psi to about 60,000 psi, alternatively about 60,000 psi to about 70,000 psi, alternatively about 80,000 psi to about 90,000 psi, alternatively about 90,000 psi to about 100,000 psi.

In at least one embodiment, a film of the present disclosure can have a Dart Drop Impact Strength (or Impact Failure or Dart F50 or Dart Drop Impact), grams per mil (g/mil), in accordance with ASTM D1709—Method B. A film of the present disclosure can have a Dart Drop Impact of about 100 g/mil to about 800 g/mil, such as about 140 g/mil to about 250 g/mil, alternatively about 250 g/mil to about 400 g/mil, alternatively about 400 g/mil to about is 800 g/mil, such as about 700 g/mil to about 800 g/mil.

In at least one embodiment, a film of the present disclosure can have an Elmendorf Tear value (MD), in accordance with ASTM D1922 (with conditioning for 40 hours at 23° C.±2° C. and 50%±10% relative humidity) of about 40 g/mil to about 300 g/mil, such as about 100 g/mil to about 280 g/mil, such as from about 150 g/mil to about 280 g/mil, such as from about 200 g/mil to about 275 g/mil.

A film according to various embodiments can have an average Raman density of about 0.91 to about 0.950 g/cm³, such as about 0.921 to about 0.924 g/cm³. For example, films may have a density from a low value of any one of 0.91, 0.911, 0.912, 0.913, 0.914, 0.915, 0.916, 0.917, 0.918, 0.919, 0.92, 0.921, or 0.922 g/cm³ to a high value of any one of 0.945, 0.944, 0.943, 0.942, 0.941, 0.940, 0.939, 0.938, 0.937, 0.936, 0.935, 0.934, 0.933, 0.932, 0.931, or 0.930 g/cm³, with ranges of various embodiments including any combination of any upper or lower value disclosed herein.

### Production of Blown Film

Blown film extrusion involves the process of extruding the polyethylene blend (also referred to sometimes as a resin) through a die (not shown) followed by a bubble-like expansion. Advantages of manufacturing film in this manner include: (1) a single operation to produce tubing; (2) regulation of film width and thickness by control of the volume of air in the bubble; (3) high extruder output and haul-off speed; (4) elimination of end effects such as edge bead trim and nonuniform temperature that can result from flat die film extrusion; and (5) capability of biaxial orientation (allowing uniformity of mechanical properties).

As part of the process, a melt comprising the blend (or second polyethylene without HDPE) is mixed with a foaming agent and extruded through an annular slit die (not shown) to form a thin walled tube. Air is introduced via a hole in the center of the die to blow up the tube like a balloon. Mounted on top of the die, a high-speed air ring (not shown) blows onto the hot film to cool it. The foam film is drawn in an upward direction, continually cooling, until it passes through nip rolls (not shown) where the tube is flattened to create what is known as a ‘lay-flat’ tube of film. This lay-flat or collapsed tube is then taken back down the extrusion tower (not shown) via more rollers. For high output lines, air inside the bubble may also be exchanged. The lay-flat film is either wound or the edges of the film are slit off to produce two flat film sheets and wound up onto reels to produce a tube of film. For lay-flat film, the tube can be made into bags, for example, by sealing across the width of film and cutting or perforating to make each bag. This operation can be performed either in line with the blown is film process or at a later time. The blown film extrusion process is typically a continuous process.

In coextrusion lines, the number of extruders depends on the number of different materials being extruded and not necessarily on the number of layers. Current feedblock technology allows fluid flow from one extruder to be split into two or more layers in the coextrudate. In an aspect, a coextrusion feedblock arranges the different melt streams in a predetermined layer sequence and generates a melt stream for each layer. Each melt stream then meets its neighboring layers and a final planar coextrudate is formed. The coextrusion feedblock can be fixed or have variable geometry blocks. A flat die, and the synergy between the die and the feedblock, are crucial to high quality film production. The die must spread the coextrudate received from the feedblock while maintaining flatness of the film. The die requires a sufficiently short residence time in order to prevent heat transfer between layers or polymer degradation. The die must also be sufficiently strong so as to resist deformation when subjected to high pressures inherent in thin film processes. In an aspect, the present multilayer films have 7 total layers or fewer. In an aspect, the present multilayer films have 50 total layers or fewer.

### Laminates

Films described herein can be laminated to a sealant forming a laminate with desired physical properties while maintaining the optical properties of the present films. A laminate includes a sealant disposed on a film described herein. The sealant may include one or more layers of a blend. Lamination may be accomplished through any suitable method, such as extrusion lamination, heat-sealing, wet lamination or adhesive lamination.

The sealant can include a first layer, a second layer disposed on the first layer, and a third layer disposed on the second layer. Each of the first layer, the second layer, and the third layer includes a second polyethylene (or blend thereof), optionally mixed with a second or third polyethylene or other polymers or additives. A sealant may have a 1/2/3 structure where 1 is a first layer, 2 is a second layer, and 3 is a third layer (e.g. a sealant layer) disposed on a film. The second layer is disposed between the first layer and the third layer. The first layer can be an outermost layer forming a film laminate surface.

For the sealant films of a three-layer structure, the first layer, the second layer, and the third layer may be of equal thickness or alternatively the second layer may be thicker than each of the first layer and the third layer. The second polyethylene (or blend thereof) of the first layer and the second polyethylene (or blend thereof) of the second layer may be the same or different. Either the second polyethylene (or blend thereof) of the first layer or the second is polyethylene (or blend thereof) of the second layer may have a higher or lower density than that of the second polyethylene (or blend thereof) of the third layer.

It is to be understood that while the present disclosure has been described in conjunction with the specific embodiments thereof, the foregoing description is intended to illustrate and not limit the scope of the present disclosure. Other aspects, advantages, and modifications will be apparent to those skilled in the art to which the present disclosure pertains.

Therefore, the following examples are put forth so as to provide those skilled in the art with a complete disclosure and description and are not intended to limit the scope of the present disclosure.

### EXAMPLES

EXCEED™ XP8656, EXCEED™ XP8318, and EXCEED™ XP8784 LLDPE polymers, and HTA 108 HDPE polymers, were obtained from ExxonMobil Chemical Company of Houston, TX. Further, two LLDPEs with high BOCD nature (BOCD-PE1 and BOCD-PE2) were prepared using the process and catalyst system described in the examples of WO2019/083609A1.

### Blending Procedure

HDPE and LLDPE stabilized pellets were physically blended before being fed to the film line extruder using online hoppers. The percentages are by weight.

In film packaging, one of the most common procedures to achieve high stiffness is to add HDPE to LLDPE resins. One issue is that by increasing HDPE loadings, the stiffness improves but consequently toughness (e.g. dart impact) might be significantly impacted.

In some cases, blends of an EXCEED™ XP—HTA108 have shown the so-called dart and tear plateau, i.e. dart and tear values are maintained constant and 1% secant modulus increase. However, a well-defined dart plateau was observed in EXCEED™ XP-HTA108 coextruded systems when the XP resins have a density of <0.918 g/cm³.

In order to extend the advantage of having a dart and tear plateau with higher stiffness, a new design was discovered with, for example, BOCD-PE2 (MI of 0.7 and density of 0.920 g/cm³). The BOCD-PE2 resin provides a dart plateau when blended with HTA108 similarly to a blend of HDPE and EXCEED™ XP8784 (MI of 0.8, density of 0.914 g/cm³) but with a higher stiffness.

In addition, films comprised of BOCD-PE1 (0.9 MI, 0.917 g/cm³), XP8656 (0.5 MI, 0.916 g/cm³) or XP8318 (MI of 0.9 and density of 0.919 g/cm³), all with HTA108, were also is fabricated. The BOCD-PE1 blends showed what was also observed with BOCD-PE2, namely the presence of dart and tear plateau with improved stiffness when compared to the other EXCEED™ XP-HDPE systems. In this study, XP8318-HTA 108 systems did not show a dart and/or tear plateau as highlighted in other reported systems.

The molecular weight characteristics, comonomer distribution and “BOCDness” of BOCD-PE1 and BOCD-PE2 resins are some of the main parameters that provide the good synergy with HTA108:
BOCD-PET blends show improvements in film properties, i.e. higher tear resistance and 1% sec. modulus as compared to XP blends. BOCD-PET provides the possibility to increase the modulus and maintain tear and dart values. By comparing BOCD-PE1/HTA108 (90/10) with similar systems of XP8656/HTA108 (90/10) and XP8318/HTA108 (97/3) can be seen that the 1% secant modulus provided by BOCD-PET is significantly higher along both MD and TD. BOCD-PET tear values are higher than XP8656 and comparable to XP8318.
BOCD-PE2 offers the opportunity to extend the dart plateau to higher 1% sec. modulus values and thus delays the dart drop as observed for XP8784. By comparing XP8784-HTA108 (90/10) with a similar system as BOCD-PE2-HTA108 (100/0), it can be seen that 1% secant modulus of the BOCD-PE2 is significantly higher along both MD and TD for comparable tear and dart values.

Additionally, BOCD-PE2 resin offers the opportunity to avoid blending procedures. In fact, comparing BOCD-PE2-HTA108 (100/0) with XP8784-HTA108 (80/20), it can be seen how the BOCD-PE2-HTA108 (100/0) blend still has better MD tear with comparable dart and sec. modulus TD without blending any HTA108.

More details can be found below regarding the characterization of the neat resins as well as the blends. (“C” refers to comparative; “I” refers to inventive).

TABLE 1
MI, MIR and Density. Density is ASTM
D1505 and MI is ASTM D1238 method

| Property | C-1 | C-2 | C-3 | I-1 | I-2 | Matrix |
|---|---|---|---|---|---|---|
| Sample | Exceed | Exceed | Exceed | BOCD- | BOCD- | HTA108 |
| | XP8656 | XP8318 | XP8784 | PE1 | PE2 | |
| Melt index, | 0.49 | 0.94 | 0.84 | 0.89 | 0.67 | 0.74 |
| I_{2.16} | | | | | | |
| (g/10 min) | | | | | | |
| Melt index, | 14.39 | 29.12 | 24.74 | 25.99 | 17.95 | 47.06 |
| I_{21.6} | | | | | | |
| (g/10 min) | | | | | | |
| Melt Index | 29 | 31 | 29 | 29 | 27 | 64 |
| Ratio, MIR | | | | | | |
| (—) | | | | | | |
| Pellets | 0.916 | 0.919 | 0.914 | 0.917 | 0.920 | 0.962 |
| Density, | | | | | | |
| ρ (g/cm³) | | | | | | |

TABLE 2
GPC4D Resins - Data. GPC4D

| Property | C-1 | C-2 | C-3 | I-1 | I-2 | Matrix |
|---|---|---|---|---|---|---|
| Sample | Exceed | Exceed | Exceed | BOCD- | BOCD- | HTA108 |
| | XP8656 | XP8318 | XP8784 | PE1 | PE2 | |
| Weight average | 143,859 | 118,434 | 116,996 | 117,042 | 123,553 | 131,662 |
| molecular weight, | | | | | | |
| M_{w} (g/mol) (IR) | | | | | | |
| Z-average | 365,230 | 307,153 | 292,032 | 292,679 | 310,512 | 1,079,296 |
| molecular weight, | | | | | | |
| M_{z} (g/mol) (IR) | | | | | | |
| Number average | 27,971 | 25,410 | 21,062 | 17,099 | 18,450 | 11,689 |
| molecular weight, | | | | | | |
| Mₙ (g/mol) (IR) | | | | | | |
| Comonomer | 9.24 | 8.85 | 10.58 | 10.28 | 8.62 | — |
| content, C6 (wt %) | | | | | | |
| Mw/Mn Ratio | 5.1 | 4.7 | 5.6 | 6.9 | 6.7 | 11.3 |
| Mz/Mw Ratio | 2.5 | 2.6 | 2.5 | 2.5 | 2.5 | 8.2 |
| Mz/Mn Ratio | 13.1 | 12.1 | 13.9 | 17.1 | 16.8 | 92.3 |

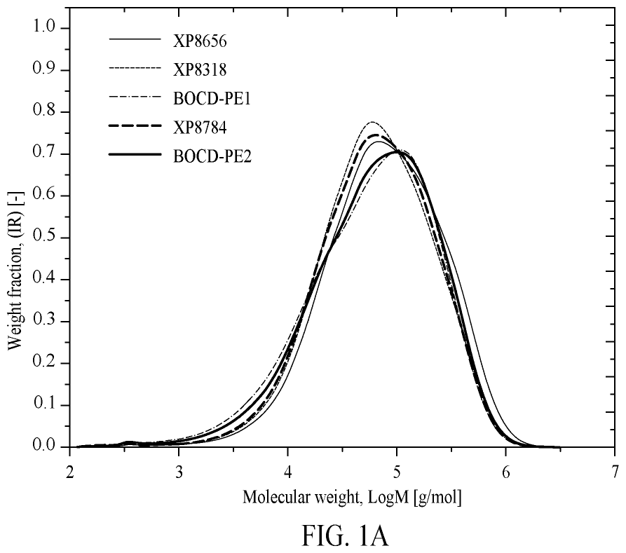

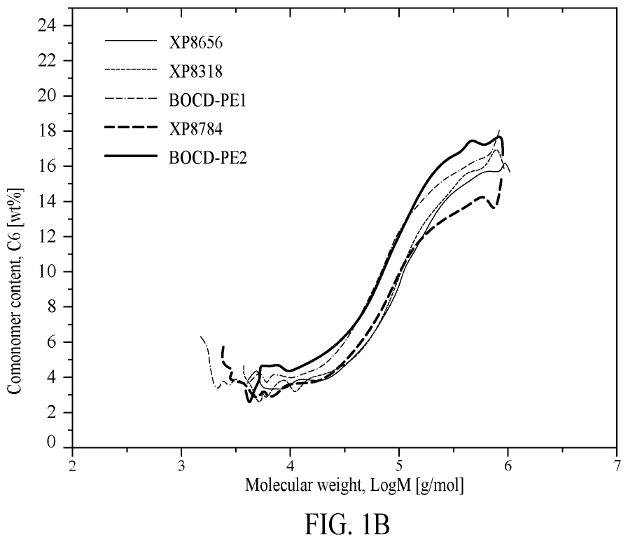

In addition, FIG. 1a is a graph illustrating the GPC4D results of the various resins. FIG. 1b is also a graph illustrating the GPC4D results of the various resins.

TABLE 2 (continued)
TREF Resins - Sample Composition Distribution. TREF IR5

| Property | C-1 | C-2 | C-3 | I-1 | I-2 | Matrix |
|---|---|---|---|---|---|---|
| Sample | Exceed | Exceed | Exceed | BOCD- | BOCD- | HTA108 |
| | XP8656 | XP8318 | XP8784 | PE1 | PE2 | |
| Very low | 18.1 | 18.0 | 28 | 27.6 | 20.2 | 2.0 |
| density, | | | | | | |
| VLD (%) | | | | | | |
| Low density, | 29.7 | 26.4 | 26.5 | 22.2 | 20.1 | 2.9 |
| LD (%) | | | | | | |
| Medium | 23.1 | 25.9 | 22.5 | 22.2 | 22.9 | 5.8 |
| density, | | | | | | |
| MD (%) | | | | | | |
| High | 29.1 | 29.7 | 22.9 | 28.0 | 36.9 | 89.2 |
| density, | | | | | | |
| HD (%) | | | | | | |
| Main peak | 91 | 91 | 91 | 93 | 94 | 98 |
| temp., Tₚₑₐₖ | | | | | | |
| (° C.) | | | | | | |
| Composition | 39 | 39 | 43 | 37 | 31 | 16 |
| distribution | | | | | | |
| breadth | | | | | | |
| index, CDBI | | | | | | |
| (%) | | | | | | |

In addition, FIG. 2 is a graph illustrating the TREF results of the resins.

### Films

5 BOCD-PE1, XP8656 and XP8784 with HTA108 films: the Alpine II film line was used to fabricate the coextruded films (monomaterial). Gauge was 2 mil, die gap was at 60 mil, die diameter was at 250 mm, blow-up ratio (BUR) was at 2.5, FLH was at ca. 30 in and extrusion rate was 4731b/h.

BOCD-PE2 and XP8784 with HTA108: the Alpine II film line was used to fabricate the monolayer films (monomaterial). Gauge was 1 mil, die gap was at 60 mil, die diameter was at 160 mm, blow-up ratio (BUR) was at 2.5, FLH was at ca. 28 in and extrusion rate was 3001b/h.

TABLE 3
Monomaterial Coextruded (1/2/1) Properties.

| | 1% Sec. | 1% Sec. | | Tear | Dart | Dart | Average |
|---|---|---|---|---|---|---|---|
| | Mod. | Mod. | Tear | MD | Drop | Drop B | Raman |
| | MD | TD | MD | Norm. | B | Norm. | Density |
| Sample | [psi] | [psi] | [g] | [g/mil] | [g] | [g/mil] | [g/cm³] |
| BOCD- | 30,486 | 41,225 | 464.3 | 232.2 | 623 | 311.5 | 0.920 |
| PE1/HTA108 | | | | | | | |
| 100/0 | | | | | | | |
| BOCD- | 32,797 | 40,801 | 509.6 | 254.8 | 511 | 255.5 | 0.921 |
| PE1/HTA108 | | | | | | | |
| 97/3 | | | | | | | |
| BOCD- | 37,515 | 44,293 | 539 | 269.5 | 535 | 267.5 | 0.923 |
| PE1/HTA108 | | | | | | | |
| 90/10 | | | | | | | |
| BOCD- | 45,275 | 51,016 | 502.7 | 251.4 | 479 | 239.5 | 0.925 |
| PE1/HTA108 | | | | | | | |
| 80/20 | | | | | | | |
| BOCD- | 56,257 | 64,486 | 304.5 | 152.3 | <295^{a} | 147.5 | 0.931 |
| PE1/HTA108 | | | | | | | |
| 65/35 | | | | | | | |
| BOCD- | 82,150 | 97,931 | 82.9 | 41.5 | <295^{a} | 147.5 | 0.940 |
| PE1/HTA108 | | | | | | | |
| 40/60 | | | | | | | |
| XP8656/HTA108 | 27,082 | 32,279 | 400.2 | 200.1 | — | — | 0.915 |
| 97/3 | | | | | | | |
| XP8656/HTA108 | 32,394 | 35,665 | 433.8 | 216.9 | — | — | 0.922 |
| 90/10 | | | | | | | |
| XP8656/HTA108 | 38,643 | 43,507 | 419.8 | 209.9 | — | — | 0.921 |
| 80/20 | | | | | | | |
| XP8656/HTA108 | 51,086 | 59,330 | 283.8 | 141.9 | — | — | 0.928 |
| 65/35 | | | | | | | |
| XP8318/HTA108 | 31,123 | 35,733 | 538.4 | 269.2 | — | — | 0.923 |
| 97/3 | | | | | | | |
| XP8318/HTA108 | 35,715 | 39,569 | 520.2 | 260.1 | — | — | 0.924 |
| 90/10 | | | | | | | |
| XP8318/HTA108 | 43,499 | 48,349 | 485 | 242.5 | — | — | 0.929 |
| 80/20 | | | | | | | |
| XP8318/HTA108 | 55,299 | 62,861 | 291.4 | 145.7 | — | — | 0.936 |
| 65/35 | | | | | | | |

^{a}When a sample fails to reach a minimum value, the method is not considered ASTM and this is what happened for 65/35 and 40/60 blends. Both failed to reach the minimum weight of 295 g after a certain number of attempts and thus in Table 3 is reported the nominal normalized value for 2 mil which is 147.5 g. The nominal values were used because a measured value by using Method B could not be obtained.

TABLE 4
Monomaterial Monolayer Properties.

| | | | 1% Sec. | 1% Sec. | | Tear | Dart | Dart | Average |
|---|---|---|---|---|---|---|---|---|---|
| | | Gauge | Mod. | Mod. | Tear | MD | Drop | Drop A | Raman |
| | | Avg. | MD | TD | MD | Norm. | A | Norm. | Density |
| Sample | BCT | [mil] | [psi] | [psi] | [g] | [g/mil] | [g] | [g/mil] | [g/cm³] |
| BOCD- | 314291 | 0.969 | 33,387 | 41,063 | 272.9 | 281.6 | 749 | 773.0 | 0.922 |
| PE2/HTA108 | | | | | | | | | |
| 100/0 | | | | | | | | | |
| BOCD- | 314292 | 0.977 | 41,061 | 51,455 | 233.4 | 238.9 | 725 | 742.1 | 0.925 |
| PE2/HTA108 | | | | | | | | | |
| 90/10 | | | | | | | | | |
| BOCD- | 314293 | 0.996 | 50,016 | 68,553 | 218.8 | 219.7 | 224 | 224.9 | 0.926 |
| PE2/HTA108 | | | | | | | | | |
| 80/20 | | | | | | | | | |
| BOCD- | 314294 | 0.991 | 60,962 | 86,172 | 44.9 | 45.3 | 147 | 148.3 | 0.930 |
| PE2/HTA108 | | | | | | | | | |
| 70/30 | | | | | | | | | |
| XP8784/HTA108 | 314295 | 0.967 | 21,376 | 26,016 | 186.3 | 192.7 | 809 | 836.6 | 0.913 |
| 100/0 | | | | | | | | | |
| XP8784/HTA108 | 314296 | 0.964 | 28,973 | 31,479 | 258.6 | 268.3 | 797 | 826.8 | 0.921 |
| 90/10 | | | | | | | | | |
| XP8784/HTA108 | 314297 | 0.978 | 37,233 | 43,289 | 249.9 | 255.5 | 755 | 772.0 | 0.923 |
| 80/20 | | | | | | | | | |
| XP8784/HTA108 | 314298 | 0.996 | 47,953 | 60,363 | 203.7 | 204.5 | 273 | 274.1 | 0.925 |
| 70/30 | | | | | | | | | |

In addition, FIG. 3a is a graph illustrating dart drop versus 1% secant modulus of films. FIG. 3b is a graph illustrating dart drop versus 1% secant modulus of a film. FIG. 3c is a graph illustrating Elmendorf tear (MD) versus 1% secant modulus of films. FIG. 3d is a graph illustrating Elmendorf tear (MD) versus 1% secant modulus of films.

The advanced characterization of the blends/films highlights further differentiation between inventive and control resins. For example, CryoCFC, TREFIR5 and GPC4D showed how the new design of the inventive resins offers a unique synergy with the used HDPE resin.

TABLE 5

| | | BOCD- | BOCD- | BOCD- | | | | |
|---|---|---|---|---|---|---|---|---|
| | | PE2/ | PE2/ | PE2/ | | XP8784/ | XP8784/ | XP8784/ |
| | BOCD- | HTA108 | HTA108 | HTA108 | | HTA108 | HTA108 | HTA108 |
| | PE2 | 90/10 | 80/20 | 70/30 | XP8784 | 90/10 | 80/20 | 70/30 |
| Very low density, | 20.2 | 18.5 | 16.6 | 14.9 | 28.3 | 25.7 | 23.2 | 20.6 |
| VLD (%) | | | | | | | | |
| Low density, LD | 20.2 | 18.4 | 16.6 | 14.9 | 26.3 | 23.9 | 21.7 | 19.4 |
| (%) | | | | | | | | |
| Medium density, | 22.4 | 21.0 | 19.2 | 17.4 | 22 | 21.4 | 19.7 | 17.8 |
| MD (%) | | | | | | | | |
| High density, HD | 37.2 | 42.1 | 47.6 | 52.8 | 22.9 | 29.0 | 35.3 | 42.3 |
| (%) | | | | | | | | |
| Main peak temp., | 93.4 | 94.9 | 95.6 | 96.2 | 90.9 | 94.9 | 95.9 | 96.4 |
| Tₚₑₐₖ (° C.) | | | | | | | | |
| Composition | 30.68 | 25.55 | 19.36 | 13.69 | 44.87 | 35.36 | 28.26 | 22.09 |
| distribution | | | | | | | | |
| breadth index, | | | | | | | | |
| CDBI (%) | | | | | | | | |

The CFC shows a defining and unique feature of the material which is the spread in temperature for polymer chains of high molecular weight and high comonomer incorporation. This spread is defined by the standard deviation σ_{T} in temperature of chains for which 0≤Tᵢ≤88° C. and 5≤Log₁₀Mⱼ≤6.

TABLE 6
CFC Blends - Data. CFC method. CFC descriptors
in the regime of high molecular weight and
high comonomer incorporation

| | | Average | |
|---|---|---|---|
| | | Raman | |
| | | Density | σ_{T} |
| Sample | BCT | [g/cm³] | (° C.) |
| BOCD- | BCT- | 0.923 | 16.45 |
| PE1/HTA108 | 314303 | | |
| 90/10 | | | |
| XP8656/HTA108 | BCT- | 0.922 | 11.23 |
| 90/10 | 303849 | | |
| XP8318/HTA108 | BCT- | 0.923 | 11.20 |
| 97/3 | 303899 | | |
| BOCD- | BCT- | 0.922 | 15.59 |
| PE2/HTA108 | 314291 | | |
| 100/0 | | | |
| XP8784/HTA108 | BCT- | 0.921 | 12.52 |
| 90/10 | 314296 | | |

### Tables 7a and 7b: TREF BOCD-PEI. XP8318, and XP8656 Blends-Sample Composition Distribution. TREF IR5

TABLE 7a

| | XP8318/ | XP8318/ | XP8318/ | XP8318/ | XP8656/ | XP8656/ | XP8656/ | XP8656/ |
|---|---|---|---|---|---|---|---|---|
| | HTA108 | HTA108 | HTA108 | HTA108 | HTA108 | HTA108 | HTA108 | HTA108 |
| | 97/3 | 90/10 | 80/20 | 65/35 | 97/03 | 90/10 | 80/20 | 65/35 |
| Very low density, | 15.1 | 13.6 | 12.4 | 10.2 | 17.4 | 16.4 | 15.3 | 12.7 |
| VLD (%) | | | | | | | | |
| Low density, LD | 28.3 | 27.1 | 24.4 | 20.3 | 29.4 | 27.2 | 24.5 | 20.3 |
| (%) | | | | | | | | |
| Medium density, | 26.2 | 25.5 | 23.5 | 19.8 | 22.5 | 21.8 | 20.0 | 17.2 |
| MD (%) | | | | | | | | |
| High density, HD | 30.4 | 33.8 | 39.7 | 49.6 | 30.7 | 34.5 | 40.2 | 49.9 |
| (%) | | | | | | | | |
| Main peak temp., | 92.5 | 94.8 | 96.0 | 96.8 | 92.8 | 94.9 | 96.0 | 96.8 |
| Tₚₑₐₖ (° C.) | | | | | | | | |
| Composition | 39.16 | 35.9 | 29.76 | 19.26 | 37.04 | 32.13 | 26.50 | 17.79 |
| distribution | | | | | | | | |
| breadth index, | | | | | | | | |
| CDBI (%) | | | | | | | | |

TABLE 7b

| | BOCD- | BOCD- | BOCD- | BOCD- | BOCD- | BOCD- |
|---|---|---|---|---|---|---|
| | PE1/ | PE1/ | PE1/ | PE1/ | PE1/ | PE1/ |
| | HTA108 | HTA108 | HTA108 | HTA108 | HTA108 | HTA108 |
| | 100/0 | 97/3 | 90/10 | 80/20 | 65/35 | 40/60 |
| Very low density, | 27.4 | 26.7 | 25.0 | 22.5 | 19.0 | 12.2 |
| VLD (%) | | | | | | |
| Low density, LD | 22.3 | 21.7 | 20.3 | 18.2 | 15.6 | 10.8 |
| (%) | | | | | | |
| Medium density, | 22.1 | 21.9 | 20.9 | 19.1 | 16.6 | 12.1 |
| MD (%) | | | | | | |
| High density, HD | 28.2 | 29.7 | 33.8 | 40.2 | 48.7 | 64.9 |
| (%) | | | | | | |
| Main peak temp., | 93.1 | 94.0 | 95.3 | 96.2 | 96.8 | 97.3 |
| Tₚₑₐₖ (° C.) | | | | | | |
| Composition | 36.71 | 35.40 | 31.27 | 25.16 | 15.93 | 10.84 |
| distribution | | | | | | |
| breadth index, | | | | | | |
| CDBI (%) | | | | | | |

### Tables 8a, 8b, and 8c: GPC4D Blends-Data. GPC4D

TABLE 8a

| | XP8318/ | XP8318/ | XP8318/ | XP8318/ | XP8656/ | XP8656/ | XP8656/ | XP8656/ |
|---|---|---|---|---|---|---|---|---|
| | HTA108 | HTA108 | HTA108 | HTA108 | HTA108 | HTA108 | HTA108 | HTA108 |
| | 97/3 | 90/10 | 80/20 | 65/35 | 97/03 | 90/10 | 80/20 | 65/35 |
| Weight average | 110,849 | 108,391 | 112,254 | 114,654 | 141,158 | 139,651 | 138,899 | 137,945 |
| molecular weight, | | | | | | | | |
| M_{w} (g/mol) (IR) | | | | | | | | |
| Z-average | 299,206 | 312,019 | 462,185 | 594,566 | 368,674 | 390,846 | 436,673 | 583,321 |
| molecular weight, | | | | | | | | |
| M_{z} (g/mol) (IR) | | | | | | | | |
| Number average | 22,025 | 20,799 | 19,273 | 16,989 | 25,053 | 23,674 | 20,456 | 17,903 |
| molecular weight, | | | | | | | | |
| Mₙ (g/mol) (IR) | | | | | | | | |
| Mw/Mn Ratio | 5.0 | 5.2 | 5.8 | 6.7 | 5.6 | 5.9 | 6.8 | 7.7 |
| Mz/Mw Ratio | 2.7 | 2.9 | 4.1 | 5.2 | 2.6 | 2.8 | 3.1 | 4.2 |
| Mz/Mn Ratio | 13.6 | 15.0 | 24.0 | 35.0 | 14.7 | 16.5 | 21.3 | 32.6 |
| Comonomer | 8.60 | 7.82 | 7.00 | 5.58 | 8.89 | 8.45 | 7.81 | 6.07 |
| content, C6 (wt %) | | | | | | | | |

TABLE 8b

| | BOCD- | BOCD- | BOCD- | BOCD- | BOCD- | BOCD- |
|---|---|---|---|---|---|---|
| | PE1/ | PE1/ | PE1/ | PE1/ | PE1/ | PE1/ |
| | HTA108 | HTA108 | HTA108 | HTA108 | HTA108 | HTA108 |
| | 100/0 | 97/3 | 90/10 | 80/20 | 65/35 | 40/60 |
| Weight average | 118,863 | 118,907 | 118,727 | 120,350 | 123,082 | 127,139 |
| molecular weight, | | | | | | |
| M_{w} (g/mol) (IR) | | | | | | |
| Z-average | 301,216 | 301,252 | 373,048 | 468,008 | 634,094 | 810,628 |
| molecular weight, | | | | | | |
| M_{z} (g/mol) (IR) | | | | | | |
| Number average | 16,970 | 17,258 | 16,353 | 15,866 | 14,957 | 13,594 |
| molecular weight, | | | | | | |
| Mₙ (g/mol) (IR) | | | | | | |
| Mw/Mn Ratio | 7.0 | 6.9 | 7.3 | 7.6 | 8.2 | 9.4 |
| Mz/Mw Ratio | 2.5 | 2.5 | 3.1 | 3.9 | 5.2 | 6.4 |
| Mz/Mn Ratio | 17.7 | 17.5 | 22.8 | 29.5 | 42.4 | 59.6 |
| Comonomer | 10.37 | 10.39 | 9.41 | 8.30 | 6.90 | 4.21 |
| content, C6 (wt %) | | | | | | |

TABLE 8c

| | | BOCD- | BOCD- | BOCD- | | | | |
|---|---|---|---|---|---|---|---|---|
| | | PE2/ | PE2/ | PE2/ | | XP8784/ | XP8784/ | XP8784/ |
| | BOCD- | HTA108 | HTA108 | HTA108 | | HTA108 | HTA108 | HTA108 |
| | PE2 | 90/10 | 80/20 | 70/30 | XP8784 | 90/10 | 80/20 | 70/30 |
| Weight average | 123,553 | 125,968 | 124,703 | 124,455 | 116,996 | 116,584 | 117,941 | 120,705 |
| molecular weight, | | | | | | | | |
| M_{w} (g/mol) (IR) | | | | | | | | |
| Z-average | 310,512 | 408,218 | 466,289 | 538,536 | 292,032 | 338,453 | 457,340 | 545,869 |
| molecular weight, | | | | | | | | |
| M_{z} (g/mol) (IR) | | | | | | | | |
| Number average | 18,450 | 17,575 | 14,994 | 14,886 | 21,062 | 21,878 | 18,470 | 17,561 |
| molecular weight, | | | | | | | | |
| Mₙ (g/mol) (IR) | | | | | | | | |
| Mw/Mn Ratio | 6.7 | 7.2 | 8.3 | 8.4 | 5.6 | 5.3 | 6.4 | 6.9 |
| Mz/Mw Ratio | 2.5 | 3.2 | 3.7 | 4.3 | 2.5 | 2.9 | 3.9 | 4.5 |
| Mz/Mn Ratio | 16.8 | 23.2 | 31.1 | 36.2 | 13.9 | 15.5 | 24.8 | 31.1 |
| Comonomer | 8.62 | 7.70 | 6.71 | 5.75 | 10.58 | 9.57 | 8.33 | 7.49 |
| content, C6 (wt %) | | | | | | | | |

The term “similar system” used herein is related to films with comparable density measured by Raman spectroscopy. This technique is very informative because it provides information directly from the film crystalline microstructure. The density is obtained by averaging 3 readings.

Temperature Rising Elution Fractionation (TREF) analysis was done using a Crystallization Elution Fractionation (CEF) instrument from Polymer Char, S.A., Valencia, Spain. The principles of CEF analysis and a general description of the particular apparatus used are given in the article Monrabal, B. et al. Crystallization Elution Fractionation. A New Separation Process for Polyolefin Resins. Macromol. Symp. 2007, 257, 71. In particular, a process conforming to the “TREF separation process” shown in FIG. 1a of this article, in which Fc=0, was used. Pertinent details of the analysis method and features of the apparatus used are as follows.

The solvent used for preparing the sample solution and for elution was 1,2-Dichlorobenzene (ODCB) filtered using a 0.1-μm Teflon filter (Millipore). The sample (16 mg) to be analyzed was dissolved in 8 ml of ODCB metered at ambient temperature by stirring (Medium setting) at 150° C. for 90 min. A small volume of the polymer solution was first filtered by an inline filter (stainless steel, 10 μm), which is back-flushed after every filtration. The filtrate was then used to completely fill a 200-μl injection-valve loop. The volume in the loop was then introduced near the center of the CEF column (15-cm long SS tubing, ⅜″ o.d., 7.8 mm i.d.) packed with an inert support (SS balls) at 140° C., and the column temperature was stabilized at 125° C. for 20 min.

The sample volume was then allowed to crystallize in the column by reducing the temperature to 0° C. at a cooling rate of 1° C./min. The column was kept at 0° C. for 10 min before injecting the ODCB flow (1 ml/min) into the column for 10 min to elute and measure the polymer that did not crystallize (soluble fraction). The wide-band channel of the infrared detector used (Polymer Char IR5) generates an absorbance signal that is proportional to the concentration of polymer in the eluting flow. A complete TREF curve was then generated by increasing the temperature of the column from 0 to 140° C. at a rate of 2° C./min while maintaining the ODCB flow at 1 ml/min to elute and measure the concentration of the dissolving polymer. The TREF curve was further processed as follows: The solvent-only response of the instrument was generated and subtracted from the TREF curve of the sample. The solvent-only response is generated by running, typically before, the same method as used for the polymer sample, but without any polymer added to the sample vial: using the same solvent reservoir as for the polymer sample and without replenishing with fresh solvent; and within a reasonable proximity of time from the run for the polymer sample.

The temperature axis of the TREF curve was appropriately shifted to correct for the delay in the IR signal caused by the column-to-detector volume. This volume is obtained by first filling the injection-valve loop with a ˜1 mg/ml solution of an HDPE resin: then loading the loop volume in the same location within the column where a sample is loaded for TREF analysis: then directly flowing, at a constant flow rate of 1 ml/min, the hot solution towards the detector using an isothermal method; and then measuring the time after injection for the HDPE probe's peak to appear in the IR signal. The delay volume (ml) is therefore equated to the time (min).

The curve was baseline corrected and appropriate integration limits were selected. And the curve was normalized so that the area of the curve is 100 wt %.

The Composition Distribution Breadth Index (CDBI) was obtained by the method described in WO 93/03093 (Meka, P. et al). Similar to the correlation shown in FIG. 16 of this reference, which was used for converting the temperature scale to a composition scale, twelve compositionally narrow polymer standards having Mn (number-averaged molecular weight) values greater than 20000 gm/mole were employed to generate a calibration line. For this purpose, the standards were analyzed by the same TREF method as the polymer samples for which CDBI values were calculated.

The TREF elution is carried out as described above, and a curve normalized so that area of the curve is 100 wt %. The curve is then partitioned into four bins and defined by their respective ranges of elution temperature, T. The four bins are designated the following nomenclature: very low density (VLD) for T<60° C., low density (LD) for 60≤T<75° C., medium density (MD) for 75≤T<87° C., and high density (HD) for T≥870C. The weight fractions of the material in each bin are readily computed from the cumulative TREF distribution by identifying the cumulative fraction at each boundary between partitions.

Cross-fractionation chromatography (CFC) analysis was done using a CFC-2 instrument from Polymer Char, S.A., Valencia, Spain. The principles of CFC analysis and a general description of the particular apparatus used are given in the article Ortin, A.: Monrabal, B.: Sancho-Tello, J. Macromol. Symp. 2007, 257, 13. FIG. 1 of the article is an appropriate schematic of the particular apparatus used. The IR4 (Polymer Char) infrared detector was used to generate an absorbance signal that is proportional to the concentration of polymer in the eluting flow: Pertinent details of the analysis method and features of the apparatus used are as follows.

The solvent used for preparing the sample solution and for elution was 1,2-Dichlorobenzene (ODCB) which was stabilized by dissolving 2 g of 2,6-bis (1,1-dimethylethyl)-4-methylphenol (butylated hydroxytoluene) in a 4-L bottle of fresh solvent at ambient temperature. The sample to be analyzed (50-65 mg) was dissolved in the solvent (25 ml metered at ambient temperature) by stirring (200 rpm) at 150° C. for 75 min. A small volume (0.5 ml) of the solution was introduced into a TREF column (stainless steel: o.d., ⅜″: length, 15 cm: packing, non-porous stainless steel micro-balls) at 150° C., and the column temperature was stabilized for 30 min at a temperature (120-125° C.) approximately 20° C. higher than the highest-temperature fraction for which the GPC analysis was included in obtaining the final bivariate distribution. The sample volume was then allowed to crystallize in the column by reducing the temperature to an appropriate low temperature (0° C.) at a cooling rate of 0.2° C./min. The low temperature was held for 10 min before injecting the solvent flow (1 ml/min) into the TREF column to elute the soluble fraction (SF) into the GPC columns (3×PLgel 10 μm Mixed-B 300×7.5 mm, Agilent Technologies, Inc.); the GPC oven was held at high temperature (140° C.). The SF was eluted for 5 min from the TREF column and then the injection valve was put in the “load” position for 40 min to completely elute all of the SF through the GPC columns (standard GPC injections). All subsequent higher-temperature fractions were analyzed using overlapped GPC injections wherein at each temperature step the polymer was allowed to dissolve for at least 16 min and then eluted from the TREF column into the GPC column for 3 min.

The set-point temperatures for these higher-temperature fractions were determined from the cumulative curve of the normalized (100 wt %) TREF curve of the same sample. The width of each temperature step, starting from the temperature of the SF, is progressively set such that a targeted 1.5 wt % of polymer mass, as indicated by the TREF cumulative curve, would elute in the temperature range of the step. However, because the temperature set-points are restricted to integer values, each step is chosen such that the polymer mass eluting in it is as close to 1.5 wt % as possible before computing the next, higher-temperature step. If greater than 1.5 wt % would elute in the minimum step size of 1° C., then the step size is set to 1° C. If the computed step size exceeds 10° C., then the step size is restricted to a maximum of 10° C. before computing the width of the next, higher-temperature step. The computation of such steps is concluded when the sum of percent polymer mass accounted in each step including the SF is 100 wt %. Additionally, two or more 1-C steps are added to ensure a complete elution of the injected polymer. The choice of 1.5 wt % is arrived at by targeting 30-35 fractions (including the SF) for the complete CFC analysis of the polymer. The computation of steps, as described above, may be done manually or with the aid of a computer program.

The universal calibration method was used for determining the molecular weight distribution (MWD) and molecular-weight averages (Mn, Mw, etc.) of eluting polymer fractions. Note that this method and calibration parameters were slightly different than those used in connection with GPC (discussed previously). In connection with the CFC analysis, twelve narrow molecular-weight-distribution polystyrene standards (obtained from Agilent Technologies, Inc.) within the range of 1.39-3039 kg/mol were used to generate a universal calibration curve. Mark-Houwink parameters were obtained from Appendix I of Mori. S.: Barth. H. G. Size Exclusion Chromatography: Springer. 1999. For polystyrene K=1.38×10-4 dl/g and α=0.7; and for polyethylene K=5.05×10-4 dl/g and α=0.693 were used. For a polymer fraction, which eluted at a temperature step, that has a weight fraction (weight % recovery) of less than 0.5%, the MWD and the molecular-weight averages were not computed: additionally, such polymer fractions were not included in computing the MWD and the molecular-weight averages of aggregates of fractions.

The population of polymer chains is separated two-dimensionally in this technique, by molecular weight and elution temperature. The strength of the detection signal Wᵢⱼ is proportional to the weight concentration of polymer chains passing the detector, and is a function of the elution temperature Tᵢ and the molecular weight Mⱼ as determined from a universal calibration curve for elution time. The indices i and j refer to the integer sequence of points in this two-dimensional data set. The σ_{T} and μ_{T} reported in Table 9 are the defined as following:

$${σ}_{T} = \sqrt{\frac{{\sum }_{i = 1}^{N} {\sum }_{j = 1}^{M} {{W}_{ij} ( {T}_{i} - {μ}_{T} )}^{2}}{{\sum }_{i = 1}^{N} {\sum }_{j = 1}^{M} {W}_{ij}}}$$

$$and$$

$${μ}_{T} = \sqrt{\frac{{\sum }_{i = 1}^{N} {\sum }_{j = 1}^{M} {W}_{ij} {T}_{i}}{{\sum }_{i = 1}^{N} {\sum }_{j = 1}^{M} {W}_{ij}}}$$

Where σ_{T} is calculated from Wᵢⱼ dataset and Tᵢ=0° C., T_{N}=88° C., T_{N}=88, log 10M₁=5, log₁₀M_{M}=6, and μ_{T} is the mean elution temperature of chains in the same data set.

TABLE 9

| | Average | | |
|---|---|---|---|
| | Raman | | |
| | Density | μ_{T} | σ_{T} |
| Sample | [g/cm³] | (° C.) | (° C.) |
| BOCD- | 0.923 | 60.76 | 16.45 |
| PE1/HTA108 | | | |
| 90/10 | | | |
| XP8656/HTA108 | 0.922 | 65.78 | 11.23 |
| 90/10 | | | |
| XP8318/HTA108 | 0.923 | 66.63 | 11.20 |
| 97/3 | | | |
| BOCD- | 0.922 | 64.86 | 15.59 |
| PE2/HTA108 | | | |
| 100/0 | | | |
| XP8784/HTA108 | 0.921 | 61.73 | 12.52 |
| 90/10 | | | |

### Multimaterial Coextruded Structures

### Example 1

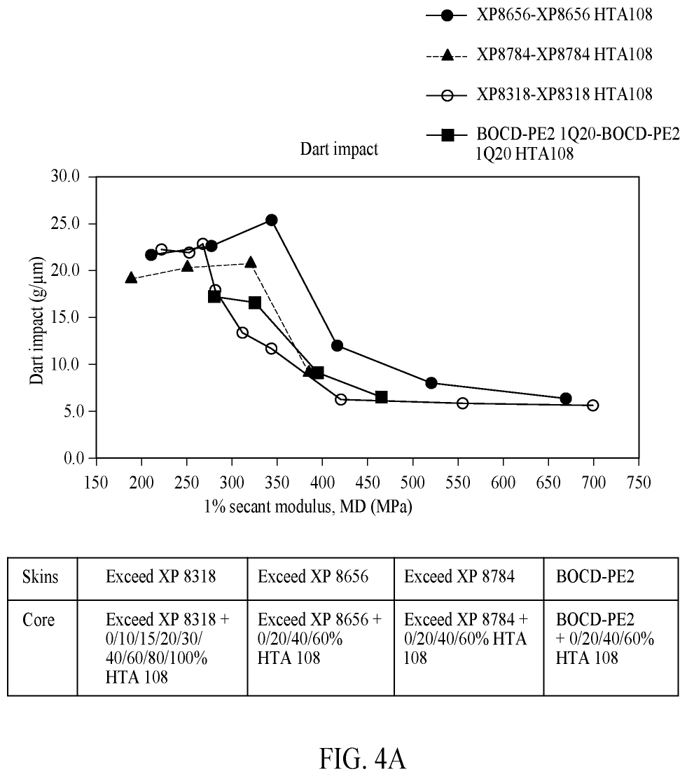

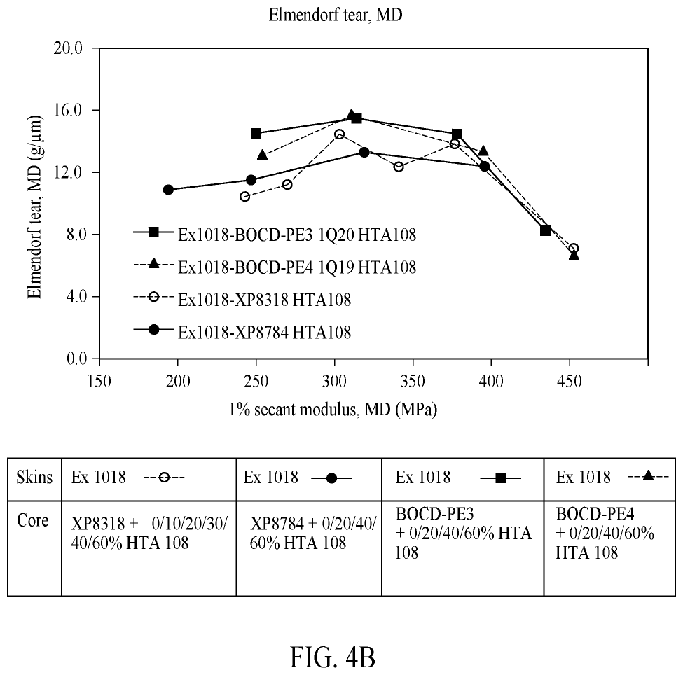

In case of coextruded structures, synergy takes place with HDPE addition in the core structure. The thickness of all films was 50 μm. FIG. 4A is graph illustrating dart impact versus 1% secant modulus (MD) for the coextruded structures. In the graph of FIG. 4a, each mark corresponds to a different HDPE percentage. Adding HDPE, the 1% secant modulus increases from left-to-right in the plot starting from 0% and so on for all other values.

The dart impact performance of some Exceed XP family retain dart impact performance even after HDPE addition. By increasing % HDPE content in the core, the dart impact trend is also confirmed with the EXC family for example BOCD-PE2.

The thickness of all films was 50 μm and layer distribution 1/2/1. The skins have neat resins and the HDPE was only added in the core structure. In the skins and core were added additives: skins: 1.5% antiblock F15 and 1% PBCE 505E slip agent and core: 1% PBCE 505E slip agent.

Additionally, FIG. 4b is graph illustrating Elmendorf tear (MD) versus 1% secant modulus (MD) for the coextruded structures. In the graph of FIG. 4b, each mark corresponds to a different HDPE percentage. The MD tear performance of some Exceed XP family improve MD tear performance after HDPE addition. Exceed XP 8656 and Exceed XP 8318 based formulation maintain or increased MD tear when adding up to 40% HTA 108.

The blown films of the coextruded structures were fabricated with an output of 225 kg/h, die gap was at 1.4 mm, die diameter was at 280 mm, blow-up ratio (BUR) was at 2.5, FLH was at ca. 900 mm layer distribution is 1/2/1, and thickness is 50 μm PE film.

### Example 2

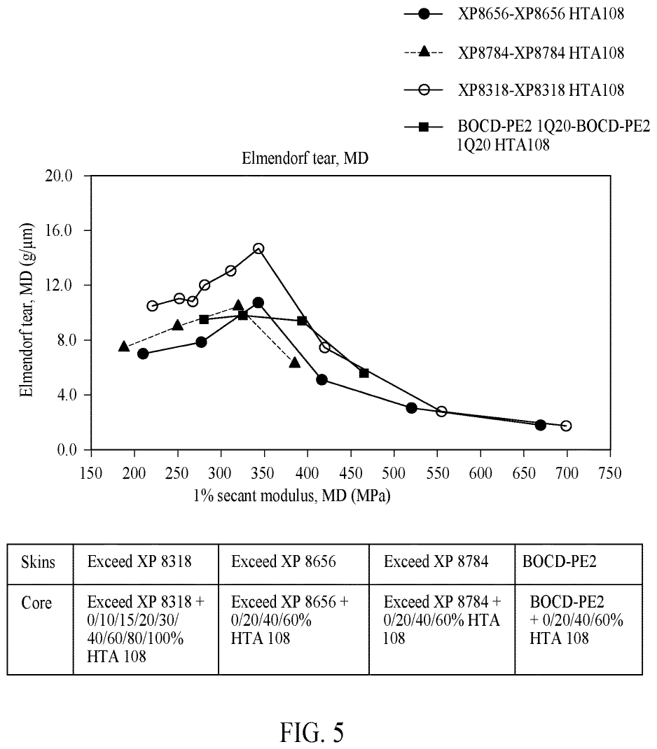

FIG. 5 is graph illustrating Elmendorf tear (MD) versus 1% secant modulus (MD) for additional coextruded structures. In the graph of FIG. 5, each mark corresponds to a different HDPE percentage.

In the graph of FIG. 5 is highlighted how BOCD-PE3 & BOCD-PE4, made using a mixed catalyst system as described herein and in WO2019/083609 in a gas phase fluidized bed reactor (also in accordance with description in WO2019/083609) can bring enhanced MD tear performance through synergy with other polymers as HDPE blend in the core and Exceed 1018 in the skin. In this example Exceed™ 1018 is used in both skin layers combined with next gen. resins and HDPE addition in the core. The blown films were fabricated with an output of 225 kg/h, die gap was at 1.4 mm, die diameter was at 280 mm, blow-up ratio (BUR) was at 2.5,

FLH was at ca. 900 mm layer distribution is 1/2/1, and thickness is 50 μm PE film. The synergy is also observed with the Exceed XP family but it is less significant (Exceed™ XP 8784/Exceed™ XP 8318 in core).

For the multimaterial coextruded structures, measurements of dart impact resistance (also referred to herein as “dart drop” or “dart drop impact”) were made using ISO 7765-1, method “A”. Measurements for 1% secant modulus can be made by following the procedure of ASTM D790A. Measurements of Elmendorf tear strength in MD and TD can be made by following the procedure of ASTM D1922-09.

Overall, it has been discovered that by using a unique class of polymers (having a density greater than 0.918 g/cm³) for mixing with an HDPE, blends (and films thereof) may be obtained that can extend the dart plateau and the tear plateau beyond that of prior blends/films, providing improved toughness and stiffness, namely a combination of high dart impact, high MD tear, and high 1% secant modulus. Without being bound by theory, it is believed that the extended dart plateau and tear plateau are provided by the homogeneous distribution (“synergy”) between the polymers having a density greater than 0.918 g/cm³ and the HDPE. Such synergy may be provided by one or more unique properties of the polymers having a density greater than 0.918 g/cm³, such properties including broad orthogonal compositional distribution, broad polydispersity indices, and a low number average molecular weight (Mn).

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of embodiments of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of this disclosure, will appreciate that other embodiments can be devised which do not depart from the scope and spirit of the present disclosure.

1. A polymer blend, comprising:
a first polyethylene having a density of about 0.94 g/cm³ to about 0.97 g/cm³ and a melt index of about 0.1 g/10 min to about 10 g/10 min; and
a second polyethylene comprising at least 80 wt % ethylene derived-units and having:
a density of greater than 0.918 g/cm³ to about 0.945 g/cm³,
a number average molecular weight (Mn) of about 10,000 g/mol to about 20,000 g/mol,
a weight-average molecular weight (Mw) of about 75,000 g/mol to about 300,000 g/mol,
a melt index (2.16 kg) of about 0.1 g/10 min to about 5 g/10 min,
a high load melt index (21.6 kg) of about 25 g/10 min to about 80 g/10 min, and
a melt index ratio of about 10 to about 50.

2. The polymer blend of claim 1, wherein the second polyethylene has a broad orthogonal composition distribution.

3. The polymer blend of claim 1, wherein the second polyethylene has one or more of the following properties:
(a) a T₇₅−T₂₅ value about 2 or greater;
(b) an M₆₀/M₉₀ value of about 2.5 or greater; and
(c) composition distribution breadth index of about 30% to about 40%.

4. The polymer blend of claim 1, wherein the second polyethylene has one or more of the following properties:
(d) an Mw of about 115,000 to about 160,000 g/mol,
(e) an Mn of about 17,000 g/mol to about 19,000 g/mol,
(f) a Z-average molecular weight (Mz) of about 250,000 g/mol to about 350,000 g/mol;
(g) an Mw/Mn value of about 6 to 7;
(h) an Mz/Mn value of about 16 to about 18; and
(i) a melt index ratio of about 25 to about 28.

5. The polymer blend of claim 4, having all of the properties (d)-(i)

6. The polymer blend of claim 1, wherein the second polyethylene has:
a melt index of about 0.5 to about 2.5,
a melt index ratio of about 25 to about 35,
a density of about 0.919 g/cm³ to about 0.927 g/cm³,
a weight average molecular weight of about 85,000 g/mol to about 135,000 g/mol,
an Mw/Mn value of about 5 to about 8, and
an Mz/Mw value of about 2 to about 4.

7. The polymer blend of claim 1, wherein the second polyethylene comprises about 94 wt % to about 98 wt % ethylene-derived units and a remainder balance of comonomer units comprising 1-hexene derived-units, based on a total weight percent of the second polyethylene.

8. The polymer blend of claim 1, wherein the blend has:
a very low density content of about 17% to about 35%,
a low density content of about 10% to about 25%,
a medium density content of about 10% to about 25%, and
a high density content of about 20% to about 70%,
wherein a total content of polymer in the blend does not exceed 100%.

9. The polymer blend of claim 1, wherein the second polyethylene is present in the blend in an amount of about 80 wt % to about 99 wt %, based on the total weight of the blend.

10. The polymer blend of claim 1, wherein the blend has an average Raman density of about 0.921 to about 0.924 g/cm³.

11. The polymer blend of claim 1 any of claims 1 to 10, wherein the blend has a sigma T (σ_{T}(° C.)) of about 12.6 to about 30.

12. The polymer blend of claim 11, wherein the blend has a (σ_{T}(C) of about 15.5 to about 17.

13. A film comprising the polymer blend of claim 1, wherein the film has a thickness of about 1 μm to about 50 μm.

14. The film of claim 13, wherein the film has:
a 1% Secant Modulus in the Machine Direction (MD), according to ASTM D882-10 (25.4 mm width strip), of about 30,000 psi to about 90,000 psi, and
a 1% Secant Modulus in the Transverse Direction (TD), according to ASTM D882-10 (25.4 mm width strip) of about 40,000 psi to about 100,000 psi.

15. The film of any of claim 13, wherein the film has a Dart Drop Impact Strength (ASTM D1709) of about 100 g/mil to about 800 g/mil.

16. The film of claim 13, wherein the film has an Elmendorf Tear value (MD), in accordance with ASTM D1922 (with conditioning for 40 hours at 23° C.±2° C. and 50%±10% relative humidity), of about 100 g/mil to about 280 g/mil.

17. The film of claim 13, wherein the film has an average Raman density of about 0.921 to about 0.924 g/cm³.
